(19) United States
(12) Patent Application Publication
(10) Pub. No.: US 2023/0376852 A1
(43) Pub. Date: Nov. 23, 2023

(54) MANAGING THE DEVELOPMENT AND USAGE OF MACHINE-LEARNING MODELS AND DATASETS VIA COMMON DATA OBJECTS

(71) Applicant: OneTrust LLC, Atlanta, GA (US)

(72) Inventors: Shane Wiggins, Atlanta, GA (US); Kevin Jones, Atlanta, GA (US)

(21) Appl. No.: 18/319,301

(22) Filed: May 17, 2023

Related U.S. Application Data
(60) Provisional application No. 63/364,970, filed on May 19, 2022.

(51) Int. Cl. G06N 20/00

(52) U.S. Cl. CPC G06N 20/00

(57) ABSTRACT

Methods, systems, and non-transitory computer readable storage media are disclosed for managing implementation of machine-learning models within computing environments according to system requirements frameworks via common data objects. The disclosed system generates a common data object to represent an implementation of a machine-learning model with a data process. For example, the disclosed system determines attribute values of the common data object according to data objects representing the machine-learning model and related datasets. Furthermore, the disclosed system utilizes the common data object to validate the machine-learning model according to a digital representation of a system requirements framework that includes usage requirements for machine-learning models to store, process, transmit, or otherwise handle specific data types in specific ways for the one or more data processes within a computing environment. The disclosed systems also perform operations to implement, suspend, or otherwise modify the machine-learning model or datasets based on the validation.

### CROSS-REFERENCE TO RELATED APPLICATIONS

This application claims priority to and the benefit of U.S. Provisional Patent Application No. 63/364,970, filed on May 19, 2022, which is incorporated herein by reference in its entirety.

### BACKGROUND

Advances in computer processing and data storage technologies have led to significant advances in the use of artificial intelligence in many industries. Specifically, many entities utilize neural networks and other machine-learning models to perform a variety of automated computing processes. Many entities in service industries receive and process large amounts of sensitive data (e.g., personal data, financial data, or other secure data) utilizing artificial intelligence. The increased prevalence of artificial intelligence in computing has resulted in many governing bodies (e.g., governments, regulatory entities, ethics/standards entities) implementing protocols/frameworks for the legal, ethical, and responsible usage of artificial intelligence via specific requirements for handling digital data using machine-learning models within computing environments. For example, the governing bodies often establish system requirements frameworks that include requirements (e.g., via software/hardware controls) for using machine-learning models to store, transmit, encrypt, process, or otherwise handle specific types of data.

Generating and managing machine-learning models to automate computing processes while complying with the protocols of various governing bodies can be a challenging and time-consuming task. Additionally, managing the data inputs and outputs of machine-learning models (e.g., verifying the sources, security, and accuracy of data) can be a challenging task given the “black box” nature of many machine-learning models. Implementing such controls is also an important aspect of ensuring that data processes implementing the machine-learning models generate accurate and secure results, especially for computing environments in which accuracy and security of digital data are critical to operations.

Conventional systems inefficiently manage machine-learning models under such protocols because the conventional systems often lack transparency in the generation and usage of machine-learning models and underlying source data. Indeed, many conventional systems are unable to manage machine-learning models in such circumstances because they lack tools for tracking and assessing the usage of the machine-learning models within various computing environments. Thus, while many conventional systems allow entities to use machine-learning to perform many computing tasks, the conventional systems typically lack the ability to control the usage of machine-learning models and verify the inputs and outputs of many machine-learning models, efficiently or otherwise.

### SUMMARY

This disclosure describes various aspects for managing implementation of machine-learning models within computing environments according to system requirements frameworks via common data objects. For example, the disclosed systems generate a common data object to represent an implementation of a machine-learning model for use with one or more data processes of a computing system. The disclosed systems determine attribute values of the common data object according to data objects representing aspects of the implementation details, including the machine-learning model and datasets associated with the machine-learning model. Furthermore, the disclosed systems utilize the common data object to determine a data configuration validation of the machine-learning model according to a digital representation of a system requirements framework that includes usage requirements for machine-learning models to store, process, transmit, or otherwise handle specific data types in specific ways for the one or more data processes within a computing environment.

In some aspects, in response to detecting a configuration gap based on the data configuration validation of the machine-learning model, the disclosed systems place a hold for implementing the machine-learning model and generate an indication of the hold for display via a graphical user interface of a computing device. In additional or alternative aspects, the disclosed systems provide recommendations for, or automatically implement, changes to correct the configuration gap by modifying the machine-learning model or corresponding datasets. The disclosed systems can also integrate with one or more computing systems to automatically implement the machine-learning model for use with the one or more data processes in response to correcting the configuration gap. The disclosed systems thus provide efficient management and implementation of a machine-learning model with various data processes across different configuration stages via a single common data object linking data objects for a plurality of different components related to the machine-learning model. The disclosed systems also provide an efficient graphical user interface for managing the implementation of the machine-learning model with the data process(es) and for providing transparency in the operations of the machine-learning model.

### BRIEF DESCRIPTION OF THE DRAWINGS

Various aspects will be described and explained with additional specificity and detail through the use of the accompanying drawings.

FIG. 1 illustrates an example of a system environment in which a machine-learning management system can operate in accordance with some aspects.

FIG. 2 illustrates an example of the machine-learning management system managing implementation of a machine-learning model for one or more data processes in connection with one or more system requirements frameworks in accordance with some aspects.

FIG. 3 illustrates an example of a common data object representing implementation details for a machine-learning in connection with a plurality of data objects representing various components of the implementation in accordance with some aspects.

FIG. 4 illustrates an example of a plurality of configuration stages and a data configuration validation for a machine-learning model in accordance with some aspects.

FIG. 5 illustrates an example of the machine-learning management system providing data discovery and classification associated with implementation details of machine-learning models in accordance with some aspects.

FIG. 6 illustrates an example of a graphical user interface for reviewing and managing implementation details of machine-learning models in accordance with some aspects.

FIG. 7 illustrates another example of a graphical user interface for reviewing and managing implementation details of machine-learning models in accordance with some aspects.

FIG. 8 illustrates another example of a graphical user interface for reviewing and managing implementation details of machine-learning models in accordance with some aspects.

FIG. 9 illustrates another example of a graphical user interface for reviewing and managing implementation details of machine-learning models in accordance with some aspects.

FIG. 10 illustrates another example of a graphical user interface for reviewing and managing implementation details of machine-learning models in accordance with some aspects.

FIG. 12 illustrates an example of a graphical user interface for managing details of a machine-learning model in accordance with some aspects.

FIG. 13 illustrates an example of a graphical user interface for managing details of a dataset associated with a machine-learning model in accordance with some aspects.

FIG. 14 illustrates an example of a graphical user interface for executing an assessment of a machine-learning model in accordance with some aspects.

FIGS. 15-17 illustrate examples of graphical user interfaces for generating and managing data configuration requirements for system requirements frameworks in accordance with some aspects.

FIG. 18 illustrates an example of a graphical user interface for providing interactive results details associated with a data configuration validation in accordance with some aspects.

FIG. 19 illustrates an example flowchart of a process for managing implementation of a machine-learning model and datasets via a common data object in accordance with some aspects.

FIG. 20 illustrates an example of a computing device in accordance with some aspects.

### DETAILED DESCRIPTION

This disclosure describes one or more aspects of a machine-learning management system that provides management and modification of machine-learning models and corresponding datasets in connection with implementing the machine-learning models according to various system requirements frameworks. For example, the machine-learning management system provides graphical user interfaces and data controls for managing, validating, and implementing machine-learning models for data processes in computing environments. To illustrate, the machine-learning management system utilizes a common data object to represent implementation details of a machine-learning model in connection with one or more data processes. The machine-learning management system can generate a single common data object related to various subcomponents of a machine-learning model for applying various controls and requirements during the development and implementation process for use with a computing application or artificial intelligence initiative. Accordingly, the machine-learning management system leverages the common data object as a single source of truth for validating accuracy, security, sensitivity, reliability, and explainability of a machine-learning model and its corresponding data in determining whether and how to implement the machine-learning model.

In some aspects, as mentioned, the machine-learning management system determines a common data object representing implementation details for a machine-learning model. Specifically, the machine-learning management system can generate the common data object including attribute values that represent various subcomponents of the machine-learning model for implementing the machine-learning model with one or more data processes (e.g., for image editing or classification, for expanding training datasets, or for text generation in casual language applications). For example, the machine-learning management system generates the common data object to link the machine-learning model to datasets associated with the machine-learning model. The machine-learning management system can also utilize the common data object to link the machine-learning model to additional subcomponents such as, but not limited to, data assets, model assessments, or risk analyses.

According to some aspects, the machine-learning management system utilizes the common data object to perform a data configuration validation of the machine-learning model and the associated data. In particular, the machine-learning management system initiates the data configuration validation of the machine-learning model to determine whether the machine-learning model meets various requirements of a system requirements framework associated with the data process(es). For instance, the machine-learning management system compares attribute values of the common data object according to a set of data configuration requirements to determine whether the implementation details of the machine-learning model conform to the system requirements framework.

Furthermore, in some aspects, in response to detecting a configuration gap indicating that the common data object does not meet the data configuration requirements, the machine-learning management system places a hold on implementing the machine-learning model. For example, the machine-learning management system can prevent implementation of the machine-learning model in response to determining that the machine-learning model and/or the datasets associated with the machine-learning model fail one or more data accuracy, security, sensitivity, or reliability requirements. To illustrate, the machine-learning management system can utilize tools integrated with third-party computing systems to prevent implementation of the machine-learning model with the one or more data processes.

Additionally, the machine-learning management system can generate an indication of the hold for implementing the machine-learning model for display via a graphical user interface of a computing device with tools to modify the machine-learning model and/or the corresponding datasets. In some aspects, the machine-learning management system determines one or more modifications to apply to the machine-learning model and/or the datasets. For example, the machine-learning management system generates one or more tasks or recommended actions to apply the modifications to the machine-learning model and/or the datasets or to apply various controls associated with a system requirements framework.

In additional or alternative aspects, in response to determining that data configuration validation indicates that the common data object meets the data configuration requirements, the machine-learning management system generates instructions to implement the machine-learning model. In particular, the machine-learning management system can generate instructions to perform the data processes utilizing the machine-learning model. For example, the machine-learning management system leverages an integration with the third-party computing systems to provide the instructions for executing the data processes with the machine-learning model.

Some aspects involve including a machine-learning management system as a component of a computing environment that includes software and/or hardware for implementing machine-learning models in connection with communication, physical, and/or information security. In these aspects, the operation of an environment including software and/or hardware for implementing machine-learning models in connection with communication, physical, and/or information security can be improved via inclusion of the machine-learning management system and operation of various data processes and rules applied by the machine-learning management system or other system (e.g., a compliance management system), as described herein. In one example, an environment can include the machine-learning management system as well as computing systems that analyze digital communication patterns for various purposes by leveraging artificial intelligence to assist in the analysis. The machine-learning management system provides tools for developing machine-learning models (e.g., neural networks) according to various system requirements frameworks associated with digital communications (e.g., including controls requiring specific encryption types or other methods of handling such data). By providing tools to manage the design and implementation of a machine-learning model for various data processes via a common data object, the machine-learning management system can utilize the common data object to validate potentially many different subcomponents related to the machine-learning model to ensure the accuracy, security, sensitivity, and reliability of the machine-learning model and the corresponding subcomponents in connection with the data processes.

In some aspects, the machine-learning management system improves upon shortcomings of conventional systems in relation to managing computing systems that implement machine-learning models for various data processes. Given the “black box” nature of many machine-learning models, such machine-learning models can often lead to unpredictable results. Accordingly, protections that constrain the use of the machine-learning models or ensure that training data and other input data complies with certain requirements can be a critical component of a computing environment. Conventional systems typically lack efficiency in tracking the use of machine-learning models and subcomponents of the machine-learning models in specific computing environments. Furthermore, conventional systems lack the ability to manage the use of machine-learning models in connection with complying with various system requirements frameworks. Thus, the conventional systems are unable to provide the necessary controls for computing environments that implement machine-learning models.

The machine-learning management system provides advantages over these conventional systems by providing tools to efficiently and accurately manage design, development, validation, discoverability, transparency, and implementation of machine-learning models in computing environments. For example, in some aspects, the machine-learning management system provides tools for managing artificial intelligence development by incorporating controls associated with system requirements frameworks into the development and implementation of machine-learning models. In particular, the machine-learning management system utilizes a common data object to track, modify, or otherwise manage use a machine-learning model and data or other subcomponents of the machine-learning model together within a computing system. By leveraging the common data object to manage implementation details of the machine-learning model, the machine-learning management system can communicate with computing applications utilizing the machine-learning model to incorporate various controls related to system requirements frameworks into the computing applications.

To illustrate, the machine-learning management system generates a common data object to enable tracking of machine-learning model implementation and usage in connection with: 1) association of the common data object to model subcomponents; 2) relation of the common data object to one or more system requirements frameworks; 3) adaptive activity detection (e.g., activity that affects data security or accuracy); and 4) lifecycle management of the machine-learning model, model data, and development operations via continuous review and analysis. In some aspects, the machine-learning management system also integrates with computing applications or computing systems to collect, modify, or otherwise manage implementation details of a machine-learning model (e.g., based on the attributes of the common data object and detection/tracking of data objects related to the common data object). In some aspects, the machine-learning management system also discovers machine-learning models via integrations with data assets (e.g., via processes that monitor data inputs/outputs of data processes to identify machine-learning models) and generates common data objects corresponding to the machine-learning models.

Leveraging the integration with the computing applications and managing machine-learning models via common data objects allows the machine-learning management system to track the use of machine-learning models within various computing applications and computing systems, as well as the inputs and outputs of the computing applications/systems. Furthermore, the machine-learning management system utilizes the common data object along with integration with one or more computing systems to implement and update (e.g., via generated recommendations presented to a client device or automatically via the integrations with the data assets) the machine-learning model according to standardized procedures for use of the machine-learning model at various stages of the model's lifecycle. The machine-learning management system can thus ensure continued relevance of the machine-learning model (e.g., via regular monitoring and assessment) in view of technical developments (e.g., changes in system requirements frameworks) that may affect artificial intelligence systems and contexts in which the systems evolve.

Additionally, the machine-learning management system can: 1) integrate with artificial intelligence applications; 2) represent areas of impact and sensitivity on digital data (e.g., files) or data assets resulting from discovering artificial intelligence applications; 3) determine design patterns for embedding into machine-learning models as features to contribute to compliant use with system requirements frameworks; 4) perform various data impact analyses; and 5) enable a continuous feedback loop for detecting and resolving configuration gaps according to data configuration requirements. The machine-learning management system also provides adaptive processes that overlay machine-learning technology to adjust to near-term risk and activity occurring between model retrains. The machine-learning management system thus provides lifecycle management of a machine-learning model within a computing environment in connection with any number of system requirements frameworks and data processes.

In some aspects, the machine-learning management system provides an improved graphical user interface for managing development and implementation of machine-learning models in connection with various data processes. For example, the machine-learning management system utilizes a common data object to provide information associated with a machine-learning model within a consolidated graphical user interface. To illustrate, by linking data objects of various subcomponents of a machine-learning model to a common data object, the machine-learning management system can efficiently obtain information associated with the subcomponents (e.g., changes to any subcomponent or configuration gaps) for display within a graphical user interface by monitoring the common data object, rather than requiring tracking of data objects of the subcomponents separately. Furthermore, the machine-learning management system can provide interactive tools for providing action recommendations to modify the subcomponents and/or for modifying the subcomponents within the graphical user interface in connection with performing data configuration validations for the machine-learning models. Accordingly, in contrast to conventional systems that utilize separate interfaces and/or applications for managing models and their respective datasets, the machine-learning management system leverages a common data object to retrieve information associated with different subcomponents of a machine-learning model and provide the information with a plurality of model management tools in a single interface/application.

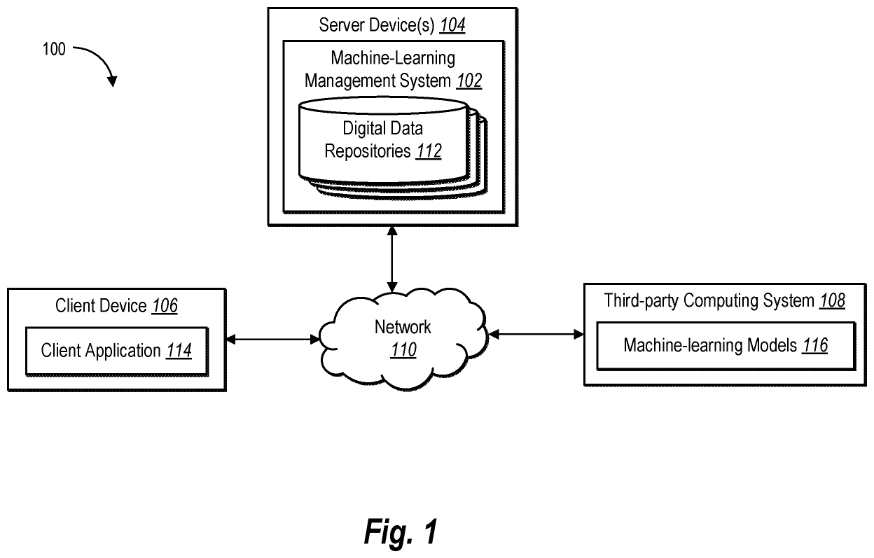

Turning now to the figures, FIG. 1 includes an embodiment of a system environment 100 in which a machine-learning management system 102 is implemented. In particular, the system environment 100 includes server device(s) 104, a client device 106, and a third-party computing system 108 in communication via a network 110. Moreover, as shown, the machine-learning management system 102 includes digital data repositories 112. FIG. 1 also shows that the client device 106 includes a client application 114, and the third-party computing system 108 includes machine-learning models 116.

As shown in FIG. 1, in some aspects, the server device(s) 104 include or host the machine-learning management system 102. Specifically, the machine-learning management system 102 includes, or is part of, one or more systems that process digital data from the digital data repositories 112 and/or the third-party computing system 108. For example, the machine-learning management system 102 provides tools to the client device 106 for managing data associated with an entity or for performing various data processes for the entity. In some aspects, the machine-learning management system 102 provides tools to the client device 106 via the client application 114 for viewing and managing information associated with data that the entity handles, including data associated with the machine-learning models 116.

As used herein, the term “data object” refers to a digital object for tracking or managing systems, software, data sources, entities, or other functions or infrastructure involved in handling specified data for an entity. For example, a data object can include a digital representation of the entity itself, a sub-entity such as subsidiary of the entity, a business unit of the entity, a data asset, a project, a machine-learning model, a dataset, or a computing operation such as a data process. In some aspects, a data object includes a “common data object” representing implementation details for a machine-learning model in connection with data processes. For example, a common data object includes a digital file with attribute values corresponding to a machine-learning model and one or more datasets associated with the machine-learning model. Additionally or alternatively, the common data object includes links to one or more additional data objects based on relationships between a machine-learning model and datasets, assessments, or risk analyses.

As used herein, the term “model object” refers to a data object representing a machine-learning model. As used herein, the term “dataset object” refers to a data object representing a dataset (e.g., one or more digital files including data used by, or generated by, a machine-learning model). As used herein, the term “assessment object” refers to a data object representing an assessment (e.g., an electronic survey). As used herein, the term “risk analysis object” refers to a data object representing information associated with a risk level or risk score corresponding to a machine-learning model. In additional or alternative aspects, data objects include, but are not limited to, control objects representing controls for system requirements frameworks, evidence objects representing evidence tasks for collecting evidence of implemented controls, or data assets (e.g., computing components) on which data processes operate.

As used herein, the term “machine-learning model” refers to a computer representation that is tuned (e.g., trained) based on inputs to approximate unknown functions. For instance, a machine-learning model includes a neural network including one or more layers or artificial neurons that approximate unknown functions by analyzing known data at different levels of abstraction. In some aspects, a machine-learning model includes one or more neural network layers including, but not limited to, a deep learning model, a convolutional neural network, a transformer neural network, a recurrent neural network, a fully-connected neural network, a classification neural network, or a combination of a plurality of neural networks and/or neural network types.

In one or more additional or alternative aspects, the machine-learning management system 102 generates/stores a data object representing a data asset including a computing component such as, but not limited to, a computing system, a software application, a website, a mobile application, or a data storage/repository. To illustrate, a data object for a data asset can represent a digital data repository (e.g., the digital data repositories 112) in the form of a database used for storing specified data. Additionally or alternatively, a data object for a data asset can represent the third-party computing system 108, or other systems. The machine-learning management system 102 thus generates and stores a plurality of data objects (e.g., at the digital data repositories 112) representing different aspects of computing operations associated with the machine-learning models 116 at the third-party computing system 108.

As used herein, the term “data process” refers to a computing process that performs one or more actions associated with specified data. In some aspects, a data process is represented by a data object (i.e., a “data process object”). For example, the machine-learning management system 102 generates/stores a data object representing a data process including, but not limited to, a computing process or action corresponding to execution of processing instructions (e.g., by utilizing a machine-learning model) to process, collect, access, store, retrieve, modify, or delete target data. To illustrate, for target data including credit card information and payment information associated with processing a credit card transaction, the machine-learning management system 102 generates a data object to represent a data process that collects the credit card information through a form (e.g., webpage) provided via the website and processes the credit card information with the appropriate card provider to process the credit card transaction. Additionally or alternatively, the target data can include analysis data from processing credit card data or user account data utilizing a machine-learning model.

In some aspects, the machine-learning management system 102 also provides tools for using the data objects to manage functions or infrastructure subject to one or more laws, regulations, or standards. To illustrate, certain types of data are subject to certain requirements/controls in how the data is handled (e.g., processed, transmitted, stored). Accordingly, the machine-learning management system 102 analyzes the data objects (e.g., via one or more data analysis projects) to determine whether the functions or infrastructure (e.g., the machine-learning models 116) represented by the data objects are in compliance with a system requirements framework that indicates the specific requirements/controls. In some aspects, a system requirements framework includes a set of computer-based requirements for handling data or otherwise configuring an entity's functions or infrastructure in accordance with a corresponding standard.

As used herein, the terms “regulation,” “standard,” and “law” refer to an established set of practices specified by a governing body such as a government, professional body, or other entity that enacts the set of practices. To illustrate, regulations, standards, or laws (also referred to collectively as “regulations” or “standards”) include, for example, a set of practices established by the International Organization for Standardization (“ISO”), internally by a particular organization (e.g., a multinational corporation), or a territory government (e.g., the European Union). The machine-learning management system 102 thus provides tools to manage the use, environment, or other attributes associated with functions or infrastructure handling specific data types and/or using machine-learning models in connection with a particular system requirements framework.

As used herein, the term “control” refers to a tool or function for satisfying a requirement from a system requirements framework for a computing environment. An example of a control is a procedure or practice for utilizing machine-learning models in a computing environment that entities are required to follow in connection with a regulation governing security or privacy. For instance, a control can include requirements for handling personally identifiable information, financial information, medical information, legal information, or other data types in machine-learning models or for providing transparency in training machine-learning models. Furthermore, as used herein, the term “control action” refers to an action to install a particular control for handling specific data types or implementing machine-learning models. To illustrate, control actions can include actions for modifying a training dataset, generating digital documentation, changing an architecture of a machine-learning model, retraining a machine-learning model according to a specific schedule, etc. Control actions can also include actions for modifying environments associated with machine-learning models, including monitoring physical environments, installing environmental protections, restricting or reviewing access authorization to physical data centers, installing physical security controls, implementing specific security or privacy rules within an organization, etc.

According to some aspects, the machine-learning management system 102 manages data objects by communicating with the digital data repositories 112 and/or the third-party computing system 108. Specifically, the machine-learning management system 102 can communicate with the digital data repositories 112 and/or the third-party computing system 108 to generate data objects for the machine-learning models 116 and/or to determine or otherwise obtain information associated with the data objects for managing the machine-learning models 116. In some aspects, one or more of the client device 106 control or use the third-party computing system 108 and/or the digital data repositories 112 for the entity. The machine-learning management system 102 can communicate with the digital data repositories 112 and/or the third-party computing system 108 on behalf of the entity via an integration that is installed on the machine-learning management system 102 that is configured with the entity's credentials (e.g., via an integrated data extraction software application). The machine-learning management system 102 can obtain metadata or other information about the infrastructure or functions used by the entity and thereby populate attributes of the data objects with this information.

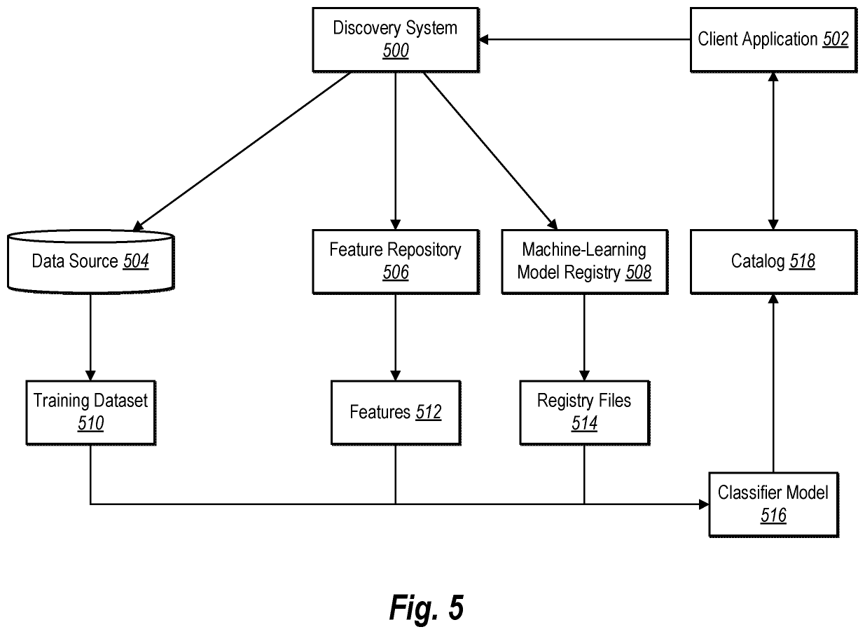

In one or more aspects, the term “data extraction software application” refers to a computing application that operates on a computing device to extract data from the computing device or another computing device. An example of a data extraction software application is the discovery system 500 described herein with respect to FIG. 5. In one example, the machine-learning management system 102 includes a data extraction software application to access the digital data repositories 112 utilizing credentials (e.g., login information, tokens) and extract (e.g., obtain) data including files, directories, or data within files. Additionally or alternatively, the machine-learning management system 102 utilizes a data extraction software application to install one or more scripts, functions, or components of the data extraction software application at one or more other computing devices (e.g., the digital data repositories 112 and/or the third-party computing system 108). Thus, the machine-learning management system 102 can integrate with the digital data repositories 112 and/or the third-party computing system 108 via the data extraction software application.

In additional or alternative aspects, the machine-learning management system 102 communicates with the client device 106 to obtain information associated with the data objects or to provide information about the data objects for display within the client application 114. For instance, the machine-learning management system 102 can obtain, via user input received from an administrator client device, metadata or other information about the infrastructure or functions (e.g., the machine-learning models 116) used by the entity and thereby populate attributes of the data objects with this information.

In some aspects, the third-party computing system 108 include server devices, individual client devices, or other computing devices associated with an entity. For instance, a third-party computing system includes one or more computing devices for performing a data process involving utilizing a machine-learning model to handle data associated with one or more operations of the entity subject to a particular system requirements framework. To illustrate, the third-party computing system includes one or more server devices that generate, process, store, or transmit payment card processing data subject to PCI DSS in one or more jurisdictions. As an example, a system requirements framework that covers processes or systems handing such data to be encrypted in a specific way, include a specific format, and/or be transmitted via specific protocols. Thus, the system requirements framework may include a requirement that machine-learning models involved in such processes be implemented in a specific way to comply with all of the corresponding data handling requirements.

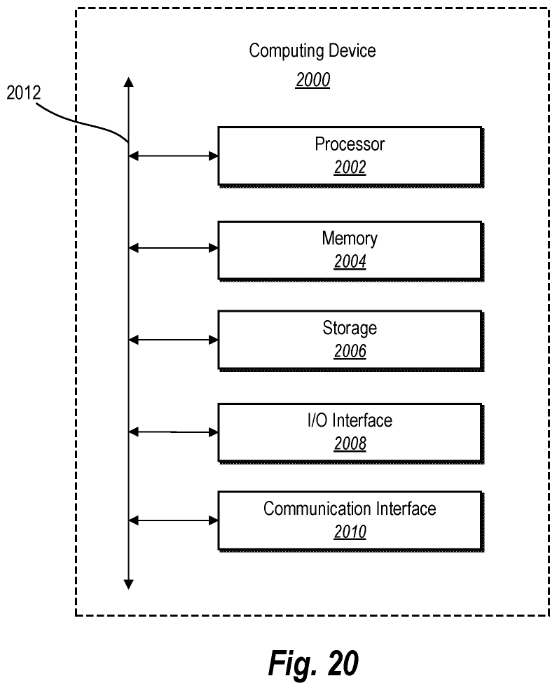

In some aspects, the server device(s) 104 include a variety of computing devices, including those described below with reference to FIG. 20. For example, the server device(s) 104 includes one or more servers for storing and processing data associated with machine-learning model management and implementation. In some aspects, the server device(s) 104 also include a plurality of computing devices in communication with each other, such as in a distributed storage environment. In some aspects, the server device(s) 104 include a content server. The server device(s) 104 also optionally includes an application server, a communication server, a web-hosting server, a social networking server, a digital content campaign server, or a digital communication management server.

In some aspects, the client device 106 includes, but is not limited to, a desktop, a mobile device (e.g., smartphone or tablet), or a laptop including those explained below with reference to FIG. 20. Furthermore, although not shown in FIG. 1, the client device 106 can be operated by users (e.g., a user included in, or associated with, the system environment 100) to perform a variety of functions. In particular, the client device 106 performs functions such as, but not limited to, accessing, viewing, and interacting with data associated with the machine-learning models 116 with one or more system requirements frameworks. In some aspects, the client device 106 also performs functions for generating, capturing, or accessing data to provide to the machine-learning management system 102 in connection with controls for the machine-learning models 116. For example, the client device 106 communicates with the server device(s) 104 via the network 110 to provide information (e.g., user interactions) associated with data objects. Although FIG. 1 illustrates the system environment 100 with a single client device, in some aspects, the system environment 100 includes a plurality of client devices. In some aspects, the client device 106 or another system hosts the digital data repositories 112.

Additionally, as shown in FIG. 1, the system environment 100 includes the network 110. The network 110 enables communication between components of the system environment 100. In some aspects, the network 110 may include the Internet or World Wide Web. In additional or alternative aspects, the network 110 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 104, the client device 106, the digital data repositories 112, and the third-party computing system 108 communicate via the network using one or more communication platforms and technologies suitable for transporting data and/or communication signals, including any known communication technologies, devices, media, and protocols supportive of data communications, examples of which are described with reference to FIG. 20.

Although FIG. 1 illustrates the server device(s) 104, the client device 106, the digital data repositories 112, and the third-party computing system 108 communicating via the network 110, in additional or alternative aspects, the various components of the system environment 100 communicate and/or interact via other methods (e.g., the server device(s) 104, the client device 106, the digital data repositories 112, and/or the third-party computing system 108 can communicate directly). Furthermore, although FIG. 1 illustrates the machine-learning management system 102 and the digital data repositories 112 being implemented separately within the system environment 100, the machine-learning management system 102 and the digital data repositories 112 can alternatively be implemented, in whole or in part, by a particular component and/or device within the system environment 100 (e.g., the server device(s) 104). Additionally or alternatively, the third-party computing system 108 can include the client device 106.

In some aspects, the server device(s) 104 support the machine-learning management system 102 on the client device 106. For instance, the server device(s) 104 generates/maintains the machine-learning management system 102 and/or one or more components of the machine-learning management system 102 (e.g., the machine-learning models 116) for the client device 106. The server device(s) 104 provides the machine-learning management system 102 to the client device 106 (e.g., as part of a software application/suite). In other words, the client device 106 obtains (e.g., downloads) the machine-learning management system 102 from the server device(s) 104. At this point, the client device 106 is able to utilize the machine-learning management system 102 to manage compliance of machine-learning models 116 according to one or more system requirements frameworks independently from the server device(s) 104.

In additional or alternative aspects, the machine-learning management system 102 includes a web hosting application that allows the client device 106 to interact with content and services hosted on the server device(s) 104. To illustrate, in some aspects, the client device 106 accesses a web page supported by the server device(s) 104. The client device 106 provides input to the server device(s) 104 to perform compliance management operations (e.g., data configuration validations), and, in response, the machine-learning management system 102 on the server device(s) 104 performs operations to view/manage data associated with machine-learning models. The server device(s) 104 provide the output or results of the operations to the client device 106.

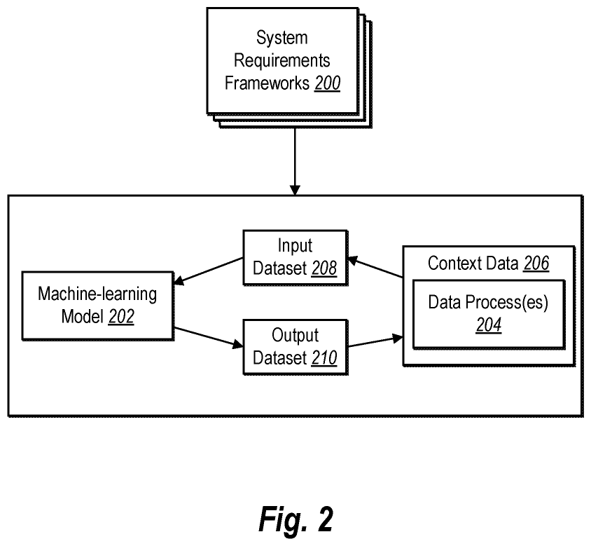

As mentioned, the machine-learning management system 102 provides management of machine-learning model development and implementation via common data objects. FIG. 2 illustrates an example of an implementation of a machine-learning model for data processes according to system frameworks requirements. For example, the machine-learning management system 102 provides tools for managing the machine-learning model and various subcomponents (e.g., input/output data) in connection with the data processes based on controls corresponding to the system requirements frameworks.

In particular, as illustrated in FIG. 2, the machine-learning management system 102 determines system requirements frameworks 200 that indicate standards that apply to one or more data processes within a computing environment. For instance, as mentioned, the machine-learning management system 102 determines one or more system requirements frameworks that apply to the use of machine-learning models within one or more specific computing environments. To illustrate, the machine-learning management system 102 determines the system requirements frameworks 200 that indicate how a machine-learning model 202 operates in connection with a data process 204.

More specifically, the machine-learning management system 102 can select the system requirements frameworks 200 based on data types handled by the machine-learning model 202 in connection with the data process 204. Additionally or alternatively, the machine-learning management system 102 can select the system requirements frameworks 200 based on the specific computing environment corresponding to the data process 204. For example, the machine-learning management system 102 determines the system requirements frameworks 200 based on context data 206 associated with the computing environment of the data process 204. To illustrate, the context data 206 can include, but is not limited to, the data process 204, one or more computing applications or data assets involved in the data process 204, one or more data domains associated with the data process 204, or geographic location/jurisdiction information associated with performing the data process.

In some aspects, the system requirements frameworks 200 include controls indicating requirements for operating the machine-learning model 202 in connection with the data process 204. For example, as previously mentioned, the controls can include a tool or function for utilizing the machine-learning model 202 according to the context data 206 associated with the data process 204. Additionally or alternatively, the controls can be associated with control actions for installing the controls to ensure that the machine-learning model 202 is utilized for the data process 204 according to the requirements of the system requirements frameworks 200. Additionally or alternatively, the controls can include control actions for using the machine-learning model 202 to store, transmit, process, or modify data within the data process 204 according to a predetermined configuration based on a system requirements framework.

According to some aspects, the machine-learning management system 102 determines one or more controls for implementing the machine-learning model 202 with the data process 204 in connection with one or more datasets associated with the machine-learning model 202. For instance, as illustrated, the machine-learning management system 102 determines that the system requirements frameworks 200 apply to an input dataset 208 and/or an output dataset 210 associated with the machine-learning model 202 in connection with performing the data process 204. To illustrate, the system requirements framework 200 can indicate requirements for handling (e.g., storing, processing, transmitting) the input dataset 208 and/or the output dataset 210. Alternatively, the system requirements frameworks 200 can indicate requirements directed to the contents of the input dataset 208 and/or the output dataset 210 (e.g., formatting or structure of digital files, documentation of the contents, data characteristics).

As described in more detail below, the machine-learning management system 102 utilizes the system requirements frameworks 200 to manage the development and implementation of the machine-learning model 202 in connection with the data process 204. In particular, the machine-learning management system 102 can provide tools for analyzing and validating the machine-learning model 202 and/or the corresponding datasets according to the system requirements frameworks 200. For example, as described in more detail below, the machine-learning management system 102 can provide tools for discovering and monitoring data inputs and outputs associated with the machine-learning model 202 while performing the data process 204 via integration with one or more computing applications and/or data assets associated with the data process 204. Furthermore, the machine-learning management system 102 can also provide tools for modifying the machine-learning model 202 and/or the corresponding datasets (e.g., via one or more control actions) to ensure compliance with the system requirements frameworks 200.

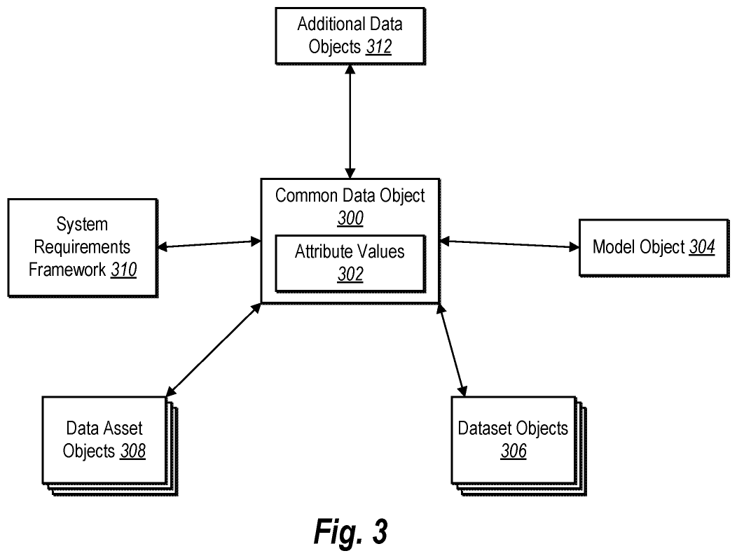

According to some aspects, the machine-learning management system 102 analyzes a machine-learning model in connection with a data process via a common data object corresponding to the machine-learning model and its subcomponents. FIG. 3 illustrates a common data object 300 representing implementation details of a machine-learning model for one or more data processes. For example, FIG. 3 illustrates that the common data object 300 is related to a plurality of data objects representing the various subcomponents of the machine-learning model within a context of a particular computing environment for the data process(es).

In some aspects, the machine-learning management system 102 accesses one or more digital data repositories, one or more data assets, and/or one or more computing applications to detect and identify a machine-learning model and one or more subcomponents of the machine-learning model. Specifically, the machine-learning management system 102 can integrate with the digital data repositories, data assets, and/or computing applications via one or more executables, scripts, or background processes that monitor data inputs and outputs. The machine-learning management system 102 can utilize the integration(s) to detect whether a machine-learning model accesses a particular data asset, dataset, computing application, or other component of a computing system during a data process based on identifiers associated with the various subcomponents. For example, the machine-learning management system 102 utilizes a discovery system as described in FIG. 5 and the corresponding description below.

In some aspects, the machine-learning management system 102 determines one or more subcomponents in response to input via a graphical user interface indicating the subcomponent(s). For example, the machine-learning management system 102 can provide tools for selecting, importing, or otherwise indicating subcomponents of an implementation of a machine-learning model with a data process. Furthermore, in some aspects, the machine-learning management system 102 detects the subcomponents prior to implementation of the machine-learning model, such as by determining the subcomponents during training or testing of the machine-learning model. Thus, the machine-learning management system 102 can manage a machine-learning model across a plurality of configuration stages of development and implementation of the machine-learning model.

In response to determining that a particular machine-learning model is associated with a data process and one or more subcomponents, the machine-learning management system 102 can generate a common data object 300 representing implementation details of the machine-learning model with the data process. For example, the machine-learning management system 102 generates including attribute values 302 representing the implementation details. In some aspects, the attribute values 302 include identifiers, mappings, or other values that correspond to details indicating associations between the common data object 300 and the various subcomponents. Furthermore, the attribute values 302 can include additional information associated with the data process and/or a project involving the data process, such as a timeline associated with the project, geographical regions associated with the project, etc.

In some aspects, the machine-learning management system 102 determines a plurality of data objects representing various subcomponents associated with implementing a machine-learning model with a data process. FIG. 3 illustrates a plurality of data objects corresponding to a machine-learning model, one or more datasets, one or more data assets, one or more system requirements frameworks, and various additional subcomponents. Accordingly, FIG. 3 illustrates that the common data object 300 is associated with the data objects corresponding to the subcomponents in connection with implementing the machine-learning model with the data process.

As illustrated, the machine-learning management system 102 determines a model object 304 representing the machine-learning model. For example, the model object 304 includes, but is not limited to, details associated with the machine-learning model, such as a model type, a storage location, input data types, and output data types. In some aspects, the model object 304 also includes an identifier that describes an instance of the machine-learning model associated with the common data object 300. Although FIG. 3 illustrates that the common data object 300 and the model object 304 include separate data objects, in additional or alternative aspects, the common data object is or includes the model object 304. Thus, the attribute values 302 of the common data object 300 can include the details associated with the instance of the machine-learning model used in connection with the project for the data process. In some aspects, the common data object 300 is linked to a plurality of model objects corresponding to a plurality of different machine-learning model instances.

In some aspects, the machine-learning management system 102 determines dataset objects 306 corresponding to datasets associated with the machine-learning model. In particular, the machine-learning management system 102 determines input datasets that include data input to the machine-learning model and/or output datasets that include data generated by the machine-learning model (e.g., as illustrated in FIG. 2). For instance, the machine-learning management system 102 generates a dataset object for one or more input datasets such as training datasets or one or more testing datasets, and/or for one or more output datasets such as datasets of predicted values or other output values generated by the machine-learning model. The dataset objects 306 can include information associated with the datasets, such as a type of data, a storage location/system of the dataset, a function of the dataset (e.g., training, testing), an owner or permissions of the dataset, and/or additional information associated with the datasets. In some aspects, the dataset objects 306 include identifiers that allow the machine-learning management system 102 to link the dataset objects 306 to the common data object 300 (e.g., in one or more mappings between the dataset objects 306 and the common data object 300).

According to some aspects, the machine-learning management system 102 determines data asset objects 308 associated with the machine-learning model. Specifically, the machine-learning management system 102 determines one or more client devices, one or more server devices, and/or one or more additional computing devices accessed in connection with performing the data process utilizing the machine-learning model. For example, the machine-learning management system 102 tracks access requests during execution of the data process to determine one or more devices on with the machine-learning model is operating and/or one or more devices that the machine-learning model accesses to obtain input data or transmit output data. Furthermore, the data asset objects 308 can include data assets for storing the datasets associated with the dataset objects 306 and/or other computing resources accessed in the training, testing, or use of the machine-learning model for the data process. Each of the data asset objects 308 can include an identifier that the machine-learning management system 102 utilizes to associate the data asset objects 308 with the common data object 300.

In at least some aspects, the machine-learning management system 102 determines a system requirements framework 310 associated with the machine-learning model. In particular, the machine-learning management system 102 generates (or otherwise determines) a digital representation of the system requirements framework 310. For instance, the machine-learning management system 102 generates a data object representing the system requirements framework 310 including information associated with controls for implementing the machine-learning model with the data process. To illustrate, the data object representing the system requirements framework 310 can include a set of requirements indicating how the machine-learning model should handle (e.g., store, transmit, process) data during operations of the data process. The data object representing the system requirements framework 310 can include an identifier that the machine-learning management system 102 utilizes to associate the common data object with the system requirements framework 310.

According to additional examples, the data object representing the system requirements framework 310 includes requirements for other subcomponents for implementing the machine-learning model with the data process. For example, the system requirements framework 310 includes controls requiring that training datasets or testing datasets associated with the machine-learning model include specific security measures or data characteristics. In some aspects, the system requirements framework 310 includes controls requiring that output datasets associated with the machine-learning model is within a threshold of an expected output dataset (e.g., the output dataset has a threshold amount of error based on a maximum error threshold or a maximum variance). In additional or alternative aspects, the system requirements framework 310 includes controls requiring specific relationships between the input data and the output data for the machine-learning model. The system requirements framework 310 can also include controls for encrypting, securing, or managing data assets accessed by the machine-learning model, including requirements on how or when the machine-learning model accesses each data asset.

In some aspects, the machine-learning management system 102 also determines additional data objects 312 representing additional subcomponents associated with a machine-learning model. For example, the additional data objects 312 can include data objects representing different configuration stages in the development and implementation of machine-learning models, such as, but not limited to, a development stage, an implementation stage, and a validation stage of the machine-learning model. In additional or alternative aspects, the machine-learning management system 102 stores information associated with the configuration stages with the attribute values 302 of the common data object 300. The additional data objects 312 can include a data object representing the data process, including information for performing the data process via one or more computing applications. The additional data objects 312 can also include data objects mapping assessments (e.g., assessment surveys) or risk analysis operations/risk levels to a machine-learning model.

As illustrated in FIG. 3, the machine-learning management system 102 generates the common data object 300 in connection with implementing a plurality of data objects. Specifically, the machine-learning management system 102 associates the common data object 300 with the other data objects by utilizing a plurality of identifiers uniquely identifying the common data object 300 and the different data objects. The machine-learning management system 102 can further store the associations/mappings between the common data object 300 within a database object or a table including the identifiers of the data objects. In some aspects, the machine-learning management system 102 generates the common data object 300 to include one or more of the mappings to the data objects associated with the subcomponents. Additionally or alternatively, the machine-learning management system 102 can utilize integrations with computing devices and computing applications to track the common data object (e.g., via the respective identifier) and corresponding subcomponents (e.g., via associations between the common data object and the respective data objects).

In connection with generating the common data object 300 and mappings to data objects of the various subcomponents, the machine-learning management system 102 can also generate mappings between the various subcomponents utilizing the common data object 300. As an example, by mapping a dataset object representing a dataset and a model object representing a machine-learning model to the common data object 300 (e.g., via a dataset identifier corresponding to the dataset and a model identifier corresponding to the machine-learning model), the machine-learning management system 102 can thus provide a mapping between the dataset object and the model object. Accordingly, the machine-learning management system 102 can determine the dataset object for the dataset based on the mapping between the model object and the dataset object via the common data object 300 (e.g., according to the attribute values of the common data object 300). In additional or alternative examples, the machine-learning management system 102 determines machine-learning models, datasets, and/or assessments associated with implementing a machine-learning model in connection with data processes by extracting the corresponding attribute values from a common data object.

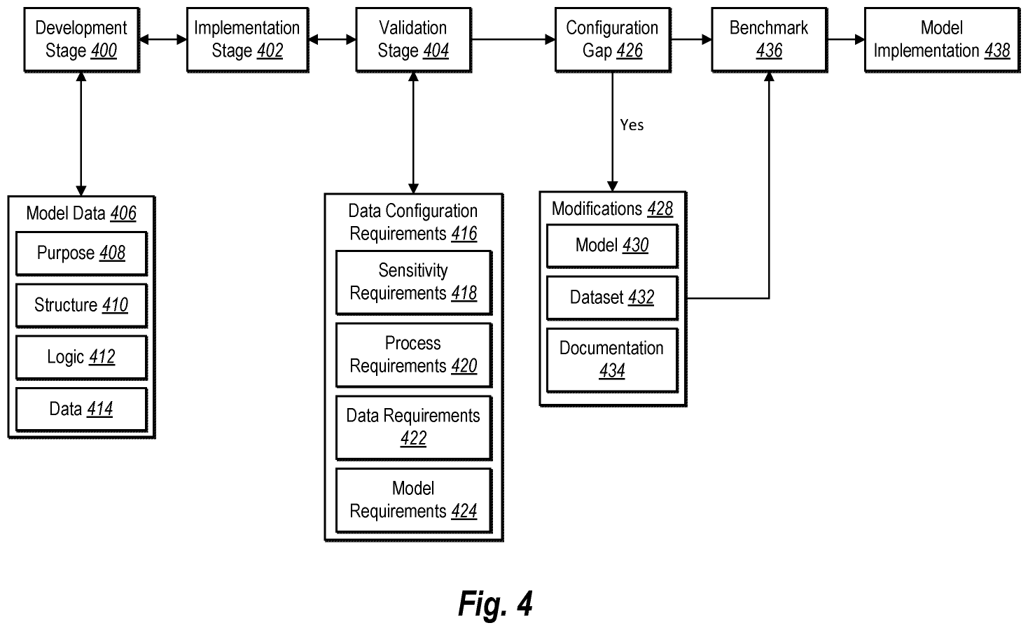

By generating a common data object associated with implementing a machine-learning model with a data process, the machine-learning management system 102 provides efficient and accurate tracking of the implementation details. For example, the machine-learning management system 102 can link the machine-learning model to each of the subcomponents for determining how implementation of the machine-learning model affects, or is affected by, the subcomponents and/or computing devices/applications. FIG. 4 illustrates an example process for tracking a machine-learning model across a plurality of configuration stages to ensure compliance of the machine-learning model implementation with one or more system requirements frameworks within a computing environment. More specifically, FIG. 4 illustrates an example of the machine-learning management system 102 leveraging a common data object to track development, implementation, and validation of a machine-learning model with a data process.

As illustrated in FIG. 4, the machine-learning management system 102 tracks a machine-learning model during a development stage 400, an implementation stage 402, or a validation stage 404. Specifically, the machine-learning management system 102 can determine that the machine-learning model is in the development stage 400 via a common data object representing the machine-learning model and the corresponding subcomponents. For example, the machine-learning management system 102 determines the current configuration stage associated with the machine-learning model in connection with one or more automated processes to track the machine-learning model via the common data object. Alternatively, the machine-learning management system 102 determines the current configuration stage associated with the machine-learning model in response to a request to review the implementation of the machine-learning model in connection with the data process.

In response to determining that the machine-learning model is in the development stage 400 (e.g., based on an identifier of the common data object and/or an identifier of a model object corresponding to the machine-learning model), the machine-learning management system 102 determines model data 406 corresponding to the machine-learning model. In particular, the machine-learning management system 102 determines the model data 406 by accessing the common data object and/or the model object associated with the machine-learning model. In some aspects, the model data 406 includes implementation details associated with the machine-learning model including, but not limited to, a purpose 408 of the machine-learning model, a structure 410 of the machine-learning model (e.g., an architecture and/or model type), a logic 412 of the machine-learning model (e.g., one or more processes in the machine-learning model and/or a description of the processes), an autonomy level of the model (e.g., completely autonomous or some human involvement) and data 414 associated with the machine-learning model (e.g., input datasets such as training datasets or testing datasets, output datasets, input/output features). In some aspects, the development stage 400 includes determining the various subcomponents associated with the machine-learning model, generating code including one or more functions utilizing the machine-learning model, or other aspects of using the machine-learning model for the data process.

According to some aspects, the machine-learning management system 102 also determines if implementation of the machine-learning model progresses from one stage to another. To illustrate, the machine-learning management system 102 can utilize the common data object to determine that the machine-learning model has moved from the development stage 400 to the implementation stage 402 (e.g., based on an attribute value of the common data object or a data object representing the stage). In some aspects, in connection with the implementation stage 402, the machine-learning management system 102 can monitor integration of the machine-learning model and/or the model data 406 with the data process. To illustrate, the machine-learning management system 102 accesses specific data assets and/or computing applications to determine that the machine-learning model is integrated for use with the data process.

Furthermore, as illustrated in FIG. 4, the machine-learning management system 102 determines that the machine-learning model moves from the implementation stage 402 to the validation stage 404 (e.g., based on the common data object and/or data object corresponding to the stage). In connection with tracking the machine-learning model in the validation stage 404, the machine-learning management system 102 utilizes the common data object to validate the implementation details relative to one or more system requirements frameworks. For example, the machine-learning management system 102 utilizes the attribute values of the common data object to identify data objects of corresponding subcomponents that are subject to requirements of the one or more system requirements frameworks.

In some aspects, the machine-learning management system 102 determines data configuration requirements 416 corresponding to the system requirements framework(s). For instance, the machine-learning management system 102 utilizes a digital representation (e.g., data object) of a system requirements framework to determine the data configuration requirements 416. Specifically, the data configuration requirements 416 can correspond to various controls including the requirements of the system requirements framework in connection with the machine-learning model, data assets, datasets, and/or other subcomponents.

To illustrate, the machine-learning management system 102 can determine sensitivity requirements 418 of the system requirements framework. The sensitivity requirements 418 can include specific types of information that are subject to the system requirements framework. For example, the machine-learning management system 102 can determine that the system requirements framework requires specific access levels, encryption, redaction, or modification of specific types of data based on the sensitivity of the data. To illustrate, the machine-learning management system 102 can determine that certain types of data (e.g., social security numbers) have a high sensitivity/priority level and require specific controls based on the system requirements framework. The machine-learning management system 102 can thus analyze the machine-learning model and/or the corresponding datasets (e.g., via the common data object and its associations with corresponding data objects) to determine whether the implementation of the machine-learning model meet the requirements of the system requirements framework.

In some aspects, the machine-learning management system 102 determines process requirements 420 of the system requirements framework. To illustrate, the machine-learning management system 102 can determine that the process requirements 420 include controls indicating that uses of machine-learning model in data processes conform to transparency protocols or resource usage limits. For example, the process requirements 420 include limitations on data storage usage, computer memory usage, bandwidth usage, or other computing resources. Accordingly, the machine-learning management system 102 can verify the implementation of the data process with the machine-learning model in view of the various resource limitations via attribute values of the common data object and/or corresponding data objects of the subcomponents.

In additional or alternative aspects, the machine-learning management system 102 can determine data requirements 422 of the system requirements framework. In particular, the machine-learning management system 102 can determine specific requirements associated with input datasets such as training datasets or testing datasets, and/or output datasets of the machine-learning model. For instance, the data requirements 422 can indicate size or file number requirements of input datasets or output datasets, statistical requirements of the input/output datasets (e.g., variability of input data, variances of output data), accuracy of data in output datasets (e.g., in comparison to ground-truth data), indications of required or prohibited data types, or other data attributes. Additionally or alternatively, the machine-learning management system 102 can utilize the data requirements 422 to compare input data and output data of the machine-learning model to verify one or more of the above-indicated attributes (e.g., based on attribute values extracted from a common data object). As an example, a comparison of an input dataset (e.g., a training dataset) to a size or statistical requirement of the data requirements 422 can indicate that the input dataset does not meet the set of data configuration requirements 416. In an additional example, a comparison of one or more characteristics of an output dataset to one or more characteristics of an expected output dataset indicates as configuration gap, such as by comparing an output variance to an expected output variance.

In additional or alternative aspects, the machine-learning management system 102 can determine model requirements 424 associated with implementing the machine-learning model with the data process. For example, the machine-learning management system 102 can determine that the model requirements 424 indicate controls for an overall system including the data process while utilizing the machine-learning model. To illustrate, the model requirements 424 can include determining and limiting the effect of the machine-learning model on one or more additional machine-learning models or data processes within the overall system. As an example, the model requirements 424 can include limiting the effect of the output of the machine-learning model on the output of an additional machine-learning model (e.g., according to a threshold value). Alternatively, the model requirements 424 include restricting the number of machine-learning models and/or specific model types within the overall system.

In some aspects, during the validation stage 404, the machine-learning management system 102 utilizes the data configuration requirements 416 to determine whether the implementation details of the machine-learning model with the data process conforms to the system requirements framework. Specifically, the machine-learning management system 102 can perform a data configuration validation that utilizes the attribute values of the common data object and data objects associated with the common data object to determine a configuration gap 426. As used herein, the term “data configuration validation” refers to one or more computer functions that operate to determine whether an implementation of a machine-learning model for one or more data processes meets one or more data configuration requirements. For instance, the machine-learning management system 102 performs the data configuration validation to identify the additional data objects linked to the common data object and compare the respective attribute values to values, thresholds, or other requirements indicated in the data configuration requirements 416. In response to determining that one or more attribute values does not meet the data configuration requirements 416 determines the configuration gap 426.

As used herein, the term “configuration gap” refers to a deficiency of functions, data, or infrastructure with regard to one or more computer-based requirements of a corresponding system requirements framework. Specifically, a configuration gap can include a deficiency of function, data, or infrastructure of a machine-learning model or subcomponents of the machine-learning model relative to data configuration requirements (e.g., the data configuration requirements 416) of a system requirements framework.

In connection with detecting the configuration gap 426, in some aspects, the machine-learning management system 102 places a hold for implementing the machine-learning model. Specifically, the machine-learning management system 102 can prevent implementation of the machine-learning model (or suspend a current implementation of the machine-learning model) for the one or more data processes. In some aspects, the machine-learning management system 102 places the hold by modifying one or more attribute values of the common data object. In additional or alternative aspects, the machine-learning management system 102 places the hold by modifying one or more attribute values of a model object corresponding to the machine-learning model.

According to some aspects, in response to detecting the configuration gap 426, the machine-learning management system 102 determines modifications 428 for ensuring compliance of the machine-learning model with the data configuration requirements 416. For example, the machine-learning management system 102 can determine whether the attribute values that cause the configuration gap 426 correspond to a model 430 (e.g., the machine-learning model itself), a dataset 432 (e.g., an input dataset such as a training dataset or a testing dataset, or an output dataset), or documentation 434 stored in connection with the model 430 or dataset 432. In some aspects, the machine-learning management system 102 determines modifications for one or more other subcomponents, such as data assets or a process that stores attribute values in the common data object or additional data objects.

In some aspects, the modifications 428 include automatic modifications via one or more processes that integrate with a computing application or computing system associated with the machine-learning model or data process. For example, the machine-learning management system 102 can generate instructions that cause the computing application or computing system to perform one or more operations to update the model 430, the dataset 432, or the documentation 434. The machine-learning management system 102 can also update the common data object and/or linked data objects according to the modifications 428.

Additionally or alternatively, the modifications 428 can include tasks or recommended actions for performing one or more processes to correct the configuration gap 426. For example, the machine-learning management system 102 can generate a recommended action to modify the model 430, the dataset 432 (or a plurality of input datasets), or the documentation 434. In some aspects, the recommended action also includes an indication to modify one or more data processes (e.g., programs or scripts) that utilize the model 430. In some aspects, generating recommended actions includes providing the recommended actions for display at a client device along with an indication of a hold for implementing the machine-learning model until the configuration gap 426 is corrected.

In one or more aspects, the machine-learning management system 102 also utilizes information associated with the configuration stage of a machine-learning model to identify a configuration gap. For example, the machine-learning management system 102 can extract one or more attribute values from a common data object related to a machine-learning model to determine a current configuration stage (e.g., development, implementation, production, validation) of the machine-learning model. In response to determining that the attribute value associated with the configuration stage of the machine-learning model does not meet a required configuration stage of the data configuration requirements 416 (e.g., a validation stage), the machine-learning management system 102 can determine a configuration gap.

In some aspects, the machine-learning management system 102 also utilizes the configuration stage requirement to determine whether to perform one or more additional validation operations related to other subcomponents of the machine-learning model. In additional or alternative aspects, the machine-learning management system 102 utilizes the attribute values associated with the configuration stage with one or more additional attribute values (e.g., corresponding to one or more datasets) to validate the subcomponents of the machine-learning model according to the specific configuration stage. Specifically, data configuration requirements for one or more subcomponents can be different for different configuration stages. The machine-learning management system 102 can perform a plurality of data configuration validations on the machine-learning model at a plurality of configuration stages. Accordingly, the machine-learning management system 102 can determine that the common data object has passed the plurality of data configuration validations corresponding to the configuration stages of the machine-learning model prior to implementing the machine-learning model.

In response to implementing the modifications 428, the machine-learning management system 102 can determine whether the updated implementation details conform to the system requirements framework. In some aspects, the machine-learning management system 102 utilizes the common data object to track the machine-learning model through one or more configuration stages according to the modified subcomponents. To illustrate, the machine-learning management system 102 can determine whether the modified attribute values of the common data object and/or linked data objects meet the data configuration requirements 416.

In some aspects, in response to determining that the attribute values of the common data object and the linked data objects meet the data configuration requirements 416, the machine-learning management system 102 determines a benchmark 436 for the machine-learning model with the data process. For example, the machine-learning management system 102 can utilize the machine-learning model to perform the data process, such as by running the machine-learning model on a testing dataset. In some aspects, the machine-learning management system 102 determines the benchmark 436 by determining a performance of the machine-learning model with the data process (e.g., key performance indicators in relation to computing resources), data capacity tests, training tests, inference tests, and/or model precision tests. The machine-learning management system 102 can, in some instances, utilize the benchmark 436 to perform additional validation for the machine-learning model relative to the data configuration requirements 416.

In response to determining that the benchmark 436 indicates that the machine-learning model passes one or more tests, the machine-learning management system 102 performs a model implementation 438. For example, the machine-learning management system 102 can move the machine-learning model out of a staging platform for the data process into a live version of the data process. To illustrate, the machine-learning management system 102 can activate the machine-learning model by pushing the machine-learning model from staging servers to live servers.

In some aspects, in response to determining that the machine-learning model meets the data configuration requirements 416 and/or passes the benchmark 436, the machine-learning management system 102 implements the machine-learning model. For example, the machine-learning management system 102 can perform an automated process to remove a hold on the machine-learning model and implement the machine-learning model (e.g., without human intervention) in response to correcting the configuration gap 426 or in response to detecting no configuration gap (e.g., in response to detecting a change to an attribute value of the common data object correcting the configuration gap according to the data configuration requirements 416). In particular, the machine-learning management system 102 can generate instructions to perform or execute one or more data processes at one or more computing devices utilizing the machine-learning model in response to determining that the implementation details meet the data configuration requirements 416 based on the attribute values of the common data object. Furthermore, the machine-learning management system 102 can provide a notification for display at a client device indicating that the hold for implementing the machine-learning model is removed. In some aspects, the machine-learning management system 102 automatically places a hold on, or implements, a machine-learning model utilizing a rules engine integrated into one or more computing applications and/or computing devices associated with the machine-learning model.

FIG. 5 illustrates an example of the machine-learning management system 102 utilizing a discovery system 500 to track a machine-learning model and subcomponents via various computing systems and computing applications. Specifically, the machine-learning management system 102 utilizes the discovery system to locate and track use of a machine-learning model, datasets, data assets, and/or other subcomponents in connection with implementing the machine-learning model for one or more data processes. In some aspects, the machine-learning management system 102 determines the subcomponents associated with implementing the machine-learning model for the data process for generating a common data object linking to the data objects of the subcomponents.

According to some aspects, the machine-learning management system 102 implements the discovery system 500 by integrating one or more executables, scripts, virtual machines, or other computing applications (e.g., an SQL function) at one or more digital data repositories, server devices, and/or client devices (e.g., on premises devices) to determine the subcomponents of the implementation. The discovery system 500 can include or access credentials (e.g., login information, tokens) that grant the discovery system 500 sufficient authorization to access the digital data repositories, server devices, and/or client devices and extract files, directories, or data within files (e.g., from one or more of a data source 504, a feature repository 506, and a machine-learning model registry 508). For instance, the machine-learning management system 102 installs the discovery system 500 on the various devices in connection with detecting and tracking the use of one or more machine-learning models for an entity by performing various operations to extract, classify, and/or publish data in connection with machine-learning models. To illustrate, the machine-learning management system 102 installs the discovery system 500 behind one or more security features (e.g., firewalls) of the devices to provide access to the discovery system 500 to all of the functions and data associated with the machine-learning model without interruption. In some aspects, the machine-learning management system 102 installs the discovery system 500 in response to a request from a client device via a client application 502, which may be associated with developing, implementing, validating, and/or otherwise managing machine-learning models or other data associated with the entity.

In additional or alternative aspects, the machine-learning management system 102 configures the discovery system 500 to reduce an impact on a performance of the one or more computing devices, servers, etc. For instance, the machine-learning management system 102 can configure the discovery system 500 to utilize bandwidth throttling techniques, such as by limiting scanning and other processing steps to non-peak times. The machine-learning management system 102 can also configure the discovery system 500 to limit performance of such operations to backup applications and data storage locations (e.g., by using sampling techniques to decrease a number of files to scan during the data discovery process).

In some aspects, as illustrated in FIG. 5, the machine-learning management system 102 utilizes the discovery system 500 to communicate with a data source 504, a feature repository 506, and a machine-learning model registry 508. In particular, the data source 504 can include a server device or other computing device that stores data for use with one or more data processes. The discovery system 500 can detect that a machine-learning model accesses one or more datasets for performing one or more functions associated with the data processes. To illustrate, the discovery system 500 determines that the machine-learning model accesses a training dataset 510 from the data source 504 in connection with training the machine-learning model. Additionally or alternatively, the discovery system 500 determines that the machine-learning model accesses a testing dataset and/or generates an output dataset at the data source 504 (or another data source).

FIG. 5 also illustrates that the machine-learning management system 102 utilizes the discovery system 500 to access the feature repository 506 that includes features 512 used by one or more machine-learning models. Specifically, the machine-learning management system 102 can utilize the discovery system 500 to determine features 512 of data that a machine-learning model to generate data as part of a data process. For example, the data process may involve the machine-learning model utilizing a subset of features available in the training dataset 510 to generate an output (e.g., a subset of demographic data including addresses, zip codes, phone numbers, or ages). The discovery system 500 can detect the features 512 based on data pulled by the machine-learning model during the data process and flag the features 512 (e.g., metadata flags). By accessing the features 512 associated with the machine-learning model, the machine-learning management system 102 can identify unexpected feature values that stand out as uncharacteristic or unusual, which may indicate problems occurring in data collection or other inaccuracies that introduce errors or bias in the results.

FIG. 5 further illustrates that the machine-learning management system 102 utilizes the discovery system 500 to access the machine-learning model registry 508 to determine components of the machine-learning model itself. For instance, the machine-learning management system 102 can utilize the discovery system 500 to access registry files 514 of the machine-learning model registry 508 to determine files (e.g., .tar or .gz files) that make up the machine-learning model, configuration files for the machine-learning model, files including a wrapper/integration script of the code for the machine-learning model, etc. The registry files 514 can include various neural network layers or other components of the machine-learning model that are accessed in connection with utilizing the machine-learning model to perform operations of the data process.

In some aspects, the machine-learning management system 102 utilizes the discovery system 500 to generate one or more data objects associated with the machine-learning models and subcomponents. For example, the machine-learning management system 102 utilizes the discovery system 500 to detect the subcomponents and generate a common data object including attribute values based on the implementation of the machine-learning model. The machine-learning management system 102 can also link the common data objects to the respective data objects of the subcomponents utilizing identifiers of the data objects. Accordingly, the machine-learning management system 102 can utilize the discovery system 500 to track the use of the machine-learning model utilizing the common data object with the linked data objects at the various devices. In some aspects, the machine-learning management system 102 also utilizes the discovery system 500 to generate data objects for the subcomponents to link to the common data object.

As an example of the above discovery operations, the machine-learning management system 102 can utilize the discovery system 500 to analyze usage of a machine-learning model by determining that images have been uploaded into a bucket of a first third-party system that stores the training dataset(s), in which a bucket includes a uniquely identifiable storage area such as a storage device or virtual storage space that the discovery system 500 identifies as a particular data source. The machine-learning management system 102 also determines that the machine-learning model uses a second third-party system as a feature repository for online applications with data at a low-latency. The machine-learning management system 102 further determines that the machine-learning model uses a third third-party system as a feature repository and as a machine-learning model registry to integrate with other services. The entity provisions the machine-learning management system 102 to scan and classify enterprise systems. As part of the scanning process, the machine-learning management system 102 discovers the correlation/relationship between the third-party systems (e.g., by linking the respective data objects to a common data object) to automatically flag the associated labels and tags for managing compliance via the machine-learning management system 102.

As another example, an entity uses a first third-party system to store transactional and log data for a ride-sharing system. The machine-learning management system 102 determines that features needed for online machine-learning models are precomputed and stored in a second third-party system. When training of the machine-learning models is complete, the machine-learning management system 102 determines that one or more data objects associated with the machine-learning models contains the following information and are stored in the second third-party system: 1) author of the model; 2) start and end time of training job; 3) model configuration; 4) reference to training and testing data; 5) feature level statistics; 6) model performance metrics; 7) learned parameters of the model; and 8) summary statistics. The machine-learning management system 102 detects the various subcomponents based on corresponding data objects and links the data objects to a common data object (e.g., via respective object identifiers).

In response to determining the separate subcomponents of the machine-learning model implementation, the machine-learning management system 102 utilizes a classifier model 516 to classify the different subcomponents—including identifying the specific subcomponents and determining priority classifications associated with the subcomponents. Specifically, the machine-learning management system 102 can utilize the classifier model 516 to determine whether a particular dataset is a training dataset (e.g., the training dataset 510), testing dataset, or output dataset (e.g., based on information from the discovery system 500). The machine-learning management system 102 can also utilize the classifier model 516 to classify the features 512, such as by identifying various data types of the features 512. The machine-learning management system 102 can utilize the classifier model 516 to classify the specific components of the machine-learning model according to the registry files 514.

As mentioned, the machine-learning management system 102 also utilizes the classifier model 516 (e.g., as part of the discovery system 500 or separate from the discovery system 500) to determine priority classifications for the subcomponents, such as by determining various sensitivity levels of the subcomponents and/or requirements corresponding to a system requirements framework. For example, the machine-learning management system 102 can determine the priority classifications based on the system requirements framework (e.g., according to data types or access levels). Furthermore, the machine-learning management system 102 can utilize the classifier model 516 to determine risk levels of the various subcomponents. For instance, the machine-learning management system 102 can determine risk levels based on model types, data types, access levels, other priority/sensitivity indications, etc.

The machine-learning management system 102 can utilize the data objects corresponding to the subcomponents to classify the subcomponents. Additionally or alternatively, the machine-learning management system 102 can store information associated with the classifications of the subcomponents in the common data object. To illustrate, the machine-learning management system 102 can store attribute values indicating priority levels, risk levels, or other classifications of the subcomponents within the common data object along with mappings to the corresponding data objects.

In response to generating the classifications for the subcomponents of the machine-learning model implementation, the machine-learning management system 102 can generate a catalog 518. Specifically, the machine-learning management system 102 can utilize the information associated with the classifications (e.g., by extracting data from the common data object) to generate a list or other data structure including details associated with the machine-learning model. In some aspects, the machine-learning management system 102 generates the catalog 518 to include details for a plurality of machine-learning models, datasets, and/or other subcomponents. The catalog 518 can include model identifiers, dataset identifiers, or data asset identifiers. The catalog 518 can further include classifications generated by the classifier model 516, including priority levels, risk levels, sensitivity levels, etc. The machine-learning management system 102 can provide the catalog for display via the client application 502 in connection with discovering machine-learning model implementations.

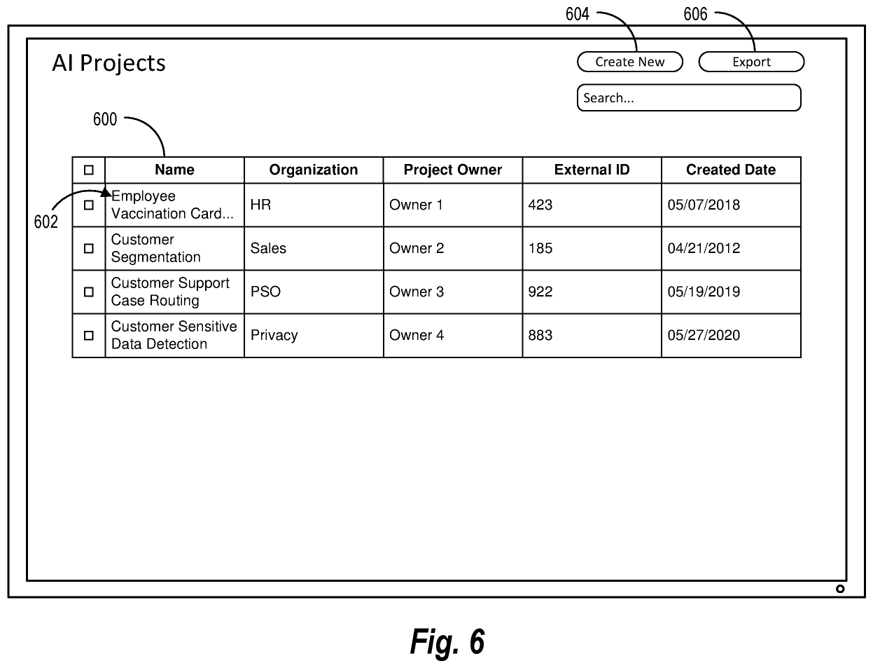

In some aspects, the machine-learning management system 102 provides tools for managing the use of machine-learning models in connection with various data processes via graphical user interfaces. Specifically, the machine-learning management system 102 provides tools for tracking and displaying details associated with developing, implementing, and validating machine-learning models across a plurality of configuration stages. Additionally or alternatively, the machine-learning management system 102 provides tools for generating and managing projects corresponding to the implementation of machine-learning models with data processes. By utilizing common data objects to track the projects via relationships to corresponding subcomponents of the machine-learning model implementations, the machine-learning management system 102 can provide tools for creating new projects, validating and/or modifying existing projects, removing projects, generating statistical analyses of projects, creating automated tools for operations associated with the projects, and otherwise viewing and interacting with information associated with the projects. FIGS. 6-18 illustrate example graphical user interfaces for managing various aspects of projects involving machine-learning models including managing a process flow of development, implementation, and validation of the machine-learning models.

FIG. 6 illustrates a graphical user interface of a client device for managing one or more projects involving artificial intelligence. Specifically, the client device can include an administrator device including an administrator application for managing various data processes associated with an entity. In some aspects, the client device displays a project list 600 including one or more projects involving machine-learning models for performing various data processes associated with an entity. To illustrate, the project list 600 includes a plurality of projects for collecting, storing, modifying, and otherwise managing digital data for one or more organizations associated with the entity. For example, as illustrated, the project list includes projects related to managing operations of a hospital, including managing medical information associated with employees, segmentation data, patient feedback, and personally identifiable information associated with patients.

As part of managing projects associated with an entity, the client device can provide identifying information associated with each project. In particular, FIG. 6 illustrates that the client device displays details such as a project name, an organization of the project, a project owner (e.g., a user account assigned to the project), an external identifier associated with the project (e.g., an identifier that the machine-learning management system 102 utilizes to access data or other subcomponents associated with the project from a third-party system, or vice-versa), and a creation date for the project. For instance, the project list 600 includes a first project 602 associated with utilizing one or more machine-learning models to perform one or more data processes in connection with the project. To illustrate, the first project 602 utilizes machine-learning to discover, manage, analyze, and/or perform additional operations in connection with managing medical information associated with employees of an entity.

Furthermore, FIG. 6 illustrates that the client device includes a first option 604 to create a new project. In response to a selection of the first option 604, the client device can display one or more interfaces for inputting and managing details associated with the new project. As part of creating a new project, the machine-learning management system 102 can generate a common data object and link one or more data objects to the new project in response to inputs via the one or more interfaces. The client device can add the new project to the project list 600 in response to creation of the new project.

Additionally or alternatively, the client device includes a second option 606 to export details associated with one or more projects. For example, in response to selecting the second option 606 with one or more selected projects, the machine-learning management system 102 can collect information associated with the project and export the information to one or more files (e.g., spreadsheets or other files accessible to one or more other computing applications). In some aspects, the machine-learning management system 102 exports the information for a project by accessing a common data object of the project (e.g., via a project identifier), determining attribute values of the common data object, and/or accessing additional data objects linked to the common data object in connection with subcomponents of the implementation of one or more machine-learning models for the project.

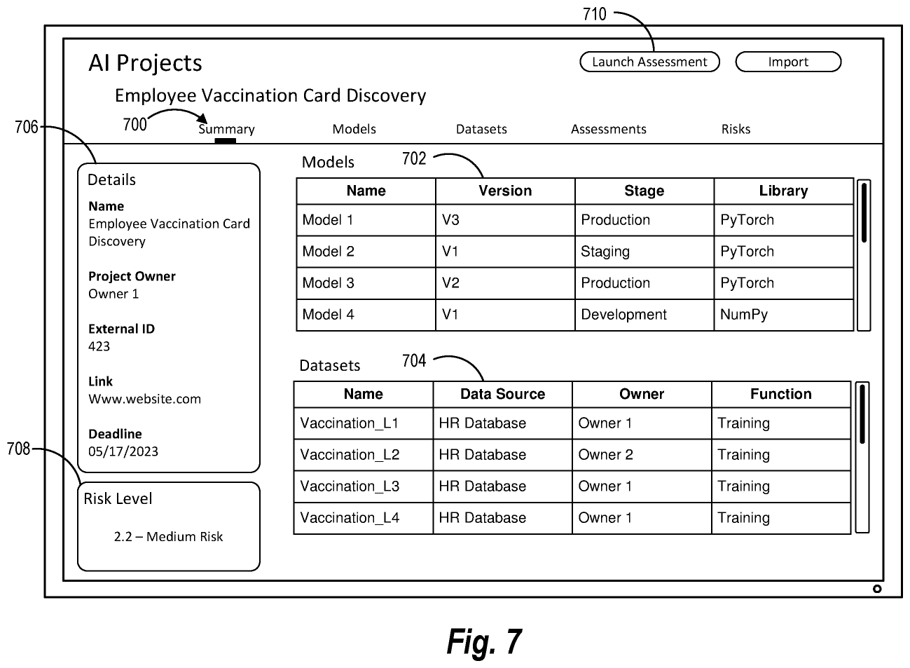

FIG. 7 illustrates a graphical user interface of a client device for displaying information associated with a selected project. For instance, in response to a selection of a project in the project list 600 of FIG. 6, the client device displays a summary interface associated with the selected project. To illustrate, the client device initially displays a summary tab 700 including information associated with various aspects of the project. More specifically, the summary interface can include an interactive summary including subcomponents of a project implementing a machine-learning model based on attribute values corresponding to a common data object of the project.

More specifically, as illustrated in FIG. 7, the summary tab 700 includes a model list 702 including information about each machine-learning model associated with the project. The summary tab 700 also includes a dataset list 704 including one or more datasets accessed by the machine-learning models for the project. The summary tab 700 can also include a details portion 706 summarizing one or more details of the project and a risk level 708 associated with the project. In some aspects, the risk level 708 corresponds to a highest risk level associated with the machine-learning models and/or the datasets. Thus, the summary tab 700 can provide a snapshot of information about the project and various subcomponents.

In some aspects, the client device also displays an assessment element 710 to launch an assessment for the project. In particular, launching an assessment causes the machine-learning management system 102 to initiate an analysis of the project and its subcomponents in connection with one or more system requirements frameworks. For example, launching an assessment includes generating and administering an assessment survey or questionnaire to obtain certain details associated with the project, as described in more detail below. In additional or alternative aspects, as described previously, launching an assessment involves the machine-learning management system 102 utilizing the common data object of the project and linked data objects to determine whether the project and its subcomponents comply with specific requirements (e.g., data storage, transmission, or other handling requirements) indicated by controls of the system requirements framework.

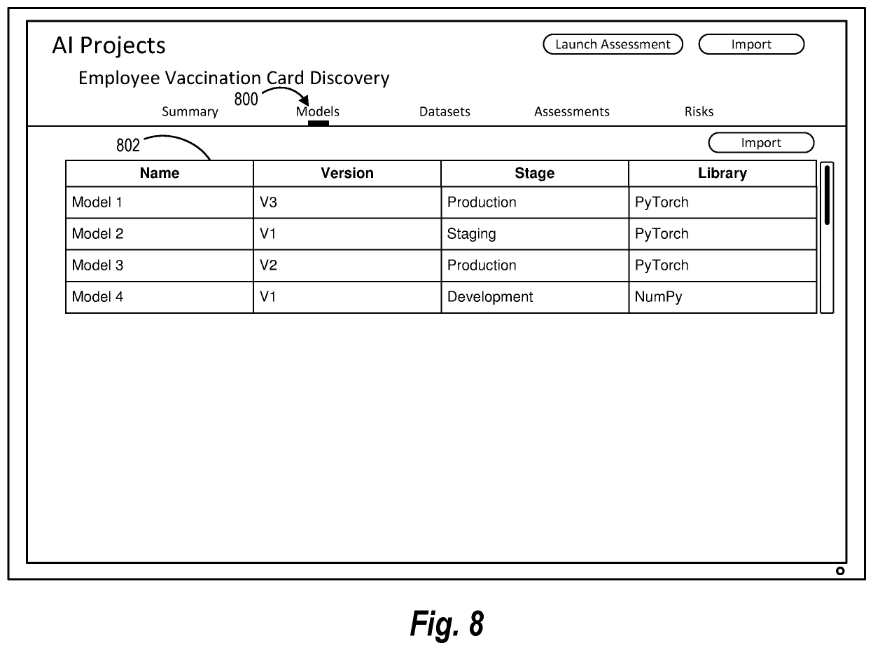

According to some aspects, selecting another tab or a specific element associated with a project causes the client device to display additional information associated with the selected tab/element. For example, FIG. 8 illustrates a graphical user interface of a client device for displaying information associated with machine-learning models for a project. To illustrate, FIG. 8 illustrates that the client device displays a models tab 800 including a summary of information about the machine-learning models for the project. Specifically, the models tab 800 includes a models list 802 with information associated with a plurality of machine-learning models.

In some aspects, the client device displays the models tab 800 including the models list 802 to provide additional information and/or options associated with managing the machine-learning models for the project. For instance, the client device can provide tools to view all of the machine-learning models associated with the project. The client device can also display information such as, but not limited to, model instances (e.g., model names), model versions, model stages, features of the models (e.g., input features, feature importance, feature impact), and/or one or more machine-learning libraries/frameworks corresponding to the machine-learning models. The machine-learning management system 102 can obtain such information from the common data object and/or the corresponding model objects. The client device can further provide tools for adding, removing, or modifying machine-learning models associated with a project via the models tab 800.

In one or more aspects, the client device also displays an indication that a particular machine-learning model is on hold in response to detecting one or more configuration gaps associated with the machine-learning model and one or more system requirements frameworks. To illustrate, the client device can display the indication of the hold on the machine-learning model with the model stage (e.g., by indicating that the machine-learning model is in a development stage). In additional or alternative aspects, the client device can change the indication of the hold in response to the machine-learning management system 102 detecting that a configuration gap is corrected. Additionally or alternatively, the machine-learning management system 102 can automatically place a hold on a machine-learning model in response to detecting a new configuration gap and cause the client device to update the status of the machine-learning model accordingly.

In some aspects, the machine-learning management system 102 determines a lineage of a machine-learning model. Specifically, the machine-learning management system 102 utilizes a common data object and/or one or more model objects to maintain a history of a model, including when the model was trained and which data/algorithms/parameters were used to train the model. In some examples, tracking the lineage involves tracking a version history of a machine-learning model. The machine-learning management system 102 can also trace the relationship between a model and its components, including experiments, datasets, containers, etc., utilizing the common data object and/or the one or more model objects. The machine-learning management system 102 utilizes such information to determine factors that contribute to a model creation, as well as artifacts and metadata that are derived from the artifact.

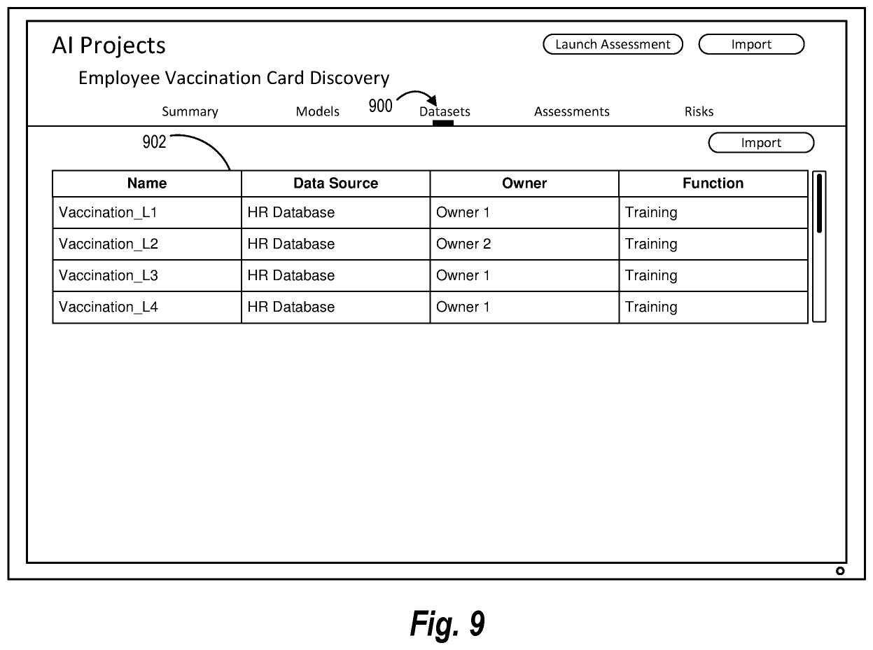

FIG. 9 illustrates a client device displaying a datasets tab 900 including information associated with datasets linked to a project, such as in response to a selection of an interactive element (e.g., a link) to view a data analysis of a selected dataset. Specifically, as shown in FIG. 9, the datasets tab 900 includes a datasets list 902 including input datasets or output datasets associated with a project. For example, the datasets list 902 includes datasets that are accessed, generated, or otherwise associated with machine-learning models for the project. To illustrate, the client device displays information such as, but not limited to, dataset names, dataset sources (e.g., locations), dataset owners (e.g., user accounts assigned to manage the datasets), and/or a function/purpose of the dataset (e.g., whether a dataset is a training dataset, testing dataset, or an output dataset). The machine-learning management system 102 can obtain the information for the datasets list by accessing the common data object and/or corresponding dataset objects.

As an example, the machine-learning management system 102 obtains information for a training dataset by extracting a dataset identifier from a dataset object in connection with one or more data processes and/or a machine-learning model. To illustrate, the machine-learning management system 102 extracts a dataset identifier associated with a dataset utilized to train a machine-learning model in connection with the data process(es). The client device can also provide tools for adding, removing, or modifying datasets associated with a project via the datasets tab 900. Furthermore, the client device an provide an interactive graphical element with a link to a data analysis of a particular dataset (e.g., the training dataset), including statistical characteristics of the dataset, a size of the dataset, or biases detected in the dataset.

In one or more aspects, the client device can also provide information indicating whether a particular dataset (e.g., an input dataset or an output dataset) meets one or more data configuration requirements associated with one or more system requirements frameworks. To illustrate, the machine-learning management system 102 can utilize a common data object associated with a machine-learning model to identify the machine-learning model and a set of data requirements applicable to the machine-learning model. In response to determining that the dataset does not meet the data requirements, the machine-learning management system 102 can cause the client device to display a notification of the data requirement and/or any deficiencies in the dataset (e.g., a configuration gap due to statistical disparity or size discrepancy).

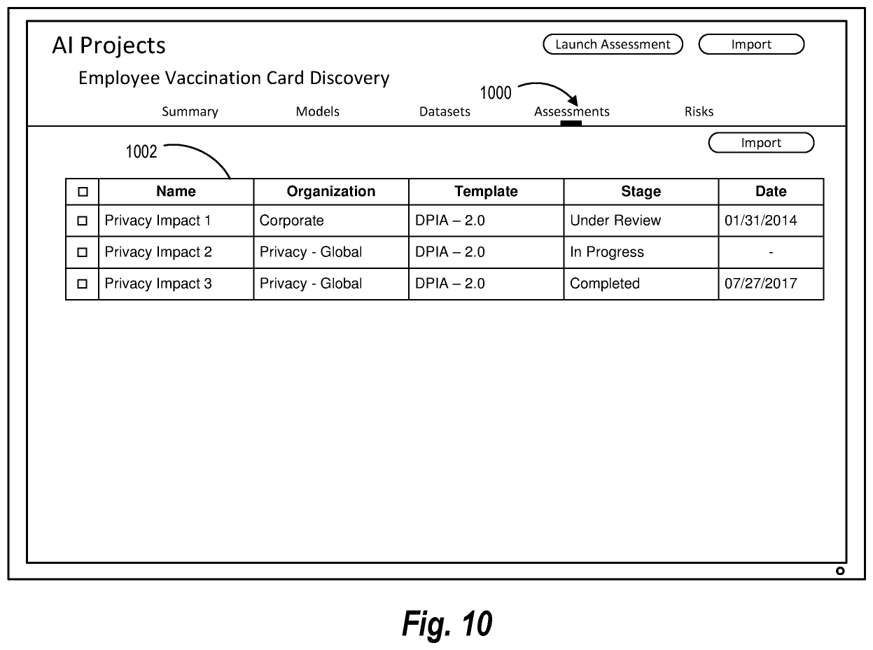

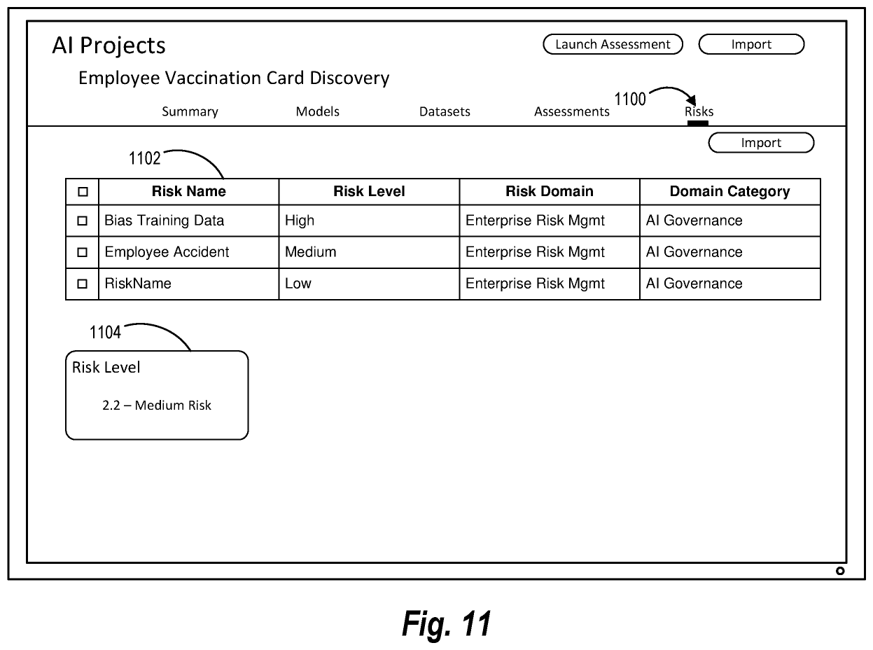

FIG. 10 illustrates a client device displaying an assessments tab 1000 including information associated with one or more assessments generated in connection with a project. In some aspects, the assessments tab 1000 includes an assessments list 1002 with assessments related to the project. As mentioned previously, the machine-learning management system 102 can launch an assessment for analyzing one or more aspects of a project. To illustrate, the machine-learning management system 102 can generate (or provide an interface for generating) an assessment survey in response to a request to launch the assessment. The machine-learning management system 102 can also administer the assessment survey to one or more client devices (e.g., the client device of FIG. 10 or to client devices associated with a specific organization) to evaluate various aspects of the project.

The client device can display information associated with a launched assessment in the assessments list 1002. For example, the assessments list 1002 can include an assessment name, an organization corresponding to the assessment, a template used to generate the assessment, a progress or configuration stage of the assessment, and a date that the assessment launched. In some aspects, the machine-learning management system 102 obtains information for assessments via data objects representing the assessment and/or responses to the assessment. Additionally or alternatively, the client device can provide tools for adding, removing, or modifying assessments associated with a project via the assessments tab 1000.

FIG. 11 illustrates a client device displaying a risks tab 1100 including information associated with risk levels of subcomponents of a project involving one or more machine-learning models. For example, the risks tab 1100 includes a risks list 1102 indicating risk levels associated with detected instances of data or subcomponents that the machine-learning management system 102 has classified as having a risk level above a risk threshold. Additionally or alternatively, the risks tab 1100 can include a risk indication 1104 of an overall/aggregated risk level for the project.

To illustrate, in connection with classifying subcomponents of machine-learning model implementation, the machine-learning management system 102 can detect that a particular subcomponent has a risk level above the risk threshold in response to detecting specific attributes of the subcomponent related to, for example, data exposure, encryption, or access controls. The machine-learning management system 102 can generate data indicating the detected risk level (e.g., by modifying an attribute level of the common data object and/or a data object of the subcomponent). The client device can add an indication of the risk level with various details associated with the detected risk to the risks list 1102. The risks list 1102 can include a description of a detected risk, a risk level, a risk domain, and a domain category. The machine-learning management system 102 can determine the information to include in the risks list 1102 by tracking the common data object of the project and/or data objects of the subcomponents during one or more data processes utilizing one or more data assets.

In some aspects, the machine-learning management system 102 determines the aggregated risk level of the project based on a plurality of detected risks. In particular, the machine-learning management system 102 can determine a plurality of risk levels associated with one or more subcomponents of the project. For example, as illustrated in FIG. 11, the risks list 1102 includes a plurality of detected risks, each of which has a specific risk level. The machine-learning management system 102 can determine the aggregated risk level of the project by averaging, summing, or otherwise combining the risk levels of the detected risks. To illustrate, each risk level can include a value on a scale (e.g., from 0 to 5), and the machine-learning management system 102 can aggregate a plurality of risk levels by averaging the values of all detected risks for the project.

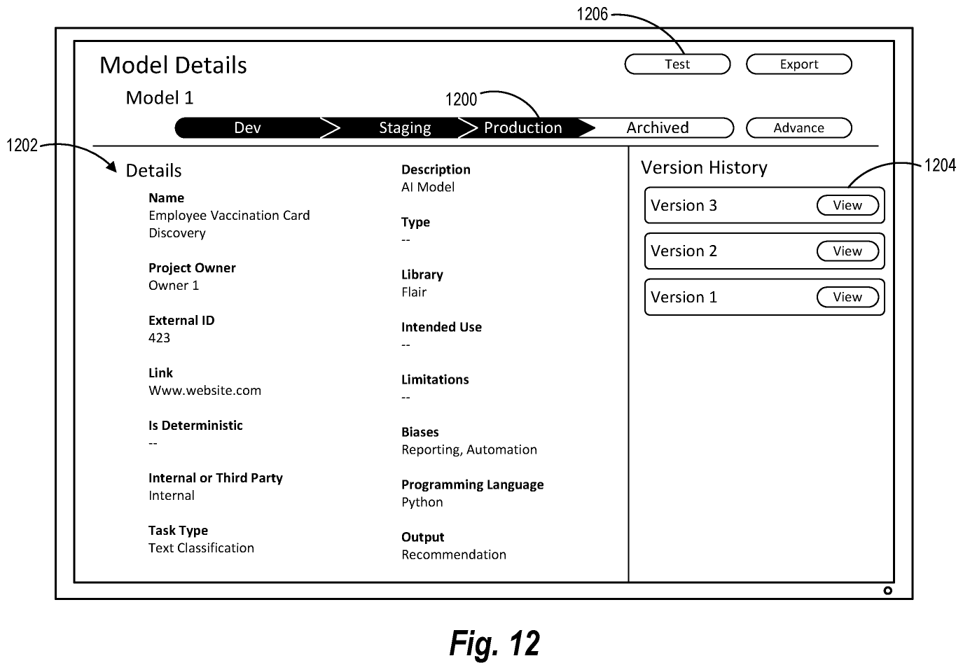

The machine-learning management system 102 can provide tools for viewing details associated with subcomponents of a project involving a machine-learning. FIG. 12 illustrates, for example, a client device displaying a detail interface for a machine-learning model associated with a project. For example, as illustrated, the client device displays details associated with the machine-learning model in response to a selection of the machine-learning model (e.g., via a summary interface or from the models tab as described previously). In some aspects, the client device displays a configuration stage 1200 associated with the machine-learning model (e.g., whether the model is in development, staging, production, or is archived).

The client device also displays model details 1202 including information that supplements the summary displayed within the models tab. For example, the client device displays information including, but not limited to, a name of the model, a user account assigned to manage the model, an external identifier, a link to the model (or a description of the model), a brief description of the model, a model type, whether the model is internal or external to computing devices of the entity, a task type associated with the data process involving the model (e.g., classification), a programming language of the model, one or more data biases of the model (e.g., based on whether training datasets are representative), a model library, an intended use of the model, any limitations detected for the model, feedback loops associated with the model, unexpected feature values, and an output of the model (e.g., a recommendation or a predicted value). The client device can also display a version 1204 of the machine-learning model in connection with training or modifying the model, along with one or more options to view specific versions of the machine-learning model. The machine-learning management system 102 can determine such details by tracking the use of the model via the common data object of the project and a model object linked to the common data object. In additional or alternative aspects, the client device can display a test element 1206 to run a testing operation on the machine-learning model utilizing one or more datasets.

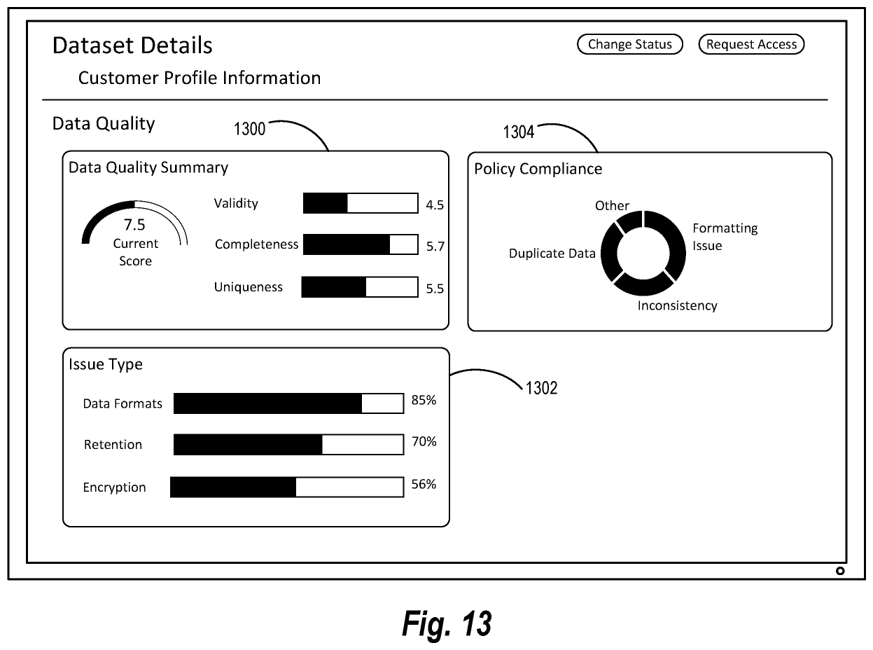

FIG. 13 illustrates an example of a client device displaying details associated with a dataset linked to a project. For example, in response to a selection of the dataset via one or more other graphical user interfaces (e.g., a summary interface or a datasets tab), the client device displays additional information associated with the selected dataset. To illustrate, the machine-learning management system 102 obtains the additional information by tracking use of the dataset via the common data object and/or a dataset object linking the dataset to the common data object.

As illustrated, the client device can display a data quality summary 1300 summarizing specific details associated with the data in the dataset. For instance, the data quality summary 1300 can include a plurality of scores corresponding to qualitative analysis of the data with respect to validity of the data, completeness of the data, and uniqueness of the data. To illustrate, the machine-learning management system 102 can utilize the common data object and/or dataset object to identify the data in the dataset and perform various tests on the data via one or more computing functions. The machine-learning management system 102 can generate the scores by determining various statistical attributes of the data (e.g., using one or more ground-truth datasets or data analysis models) and comparing the statistical attributes to threshold values. The machine-learning management system 102 can also generate an overall score of the dataset based on the plurality of scores for display via the client device.

FIG. 13 also illustrates that the client device displays an issue type summary 1302 including one or more types of issues detected in connection with the dataset. For example, the issue type summary 1302 can include information indicating whether the data in the dataset complies with various controls indicating requirements for data formats, data retention, encryption, or data validation for one or more system requirements frameworks. The machine-learning management system 102 can determine a percentage of data in the dataset that complies with the specific controls and provide the percentages for display within the issue type summary 1302. In connection with determining the compliance of the dataset with the various controls, the machine-learning management system 102 can also determine an overall compliance of the dataset with one or more system requirements frameworks for display in a compliance summary 1304. Thus, the client device can provide a snapshot of information indicating whether control actions should be implemented to modify the dataset for compliance with the system requirements frameworks.

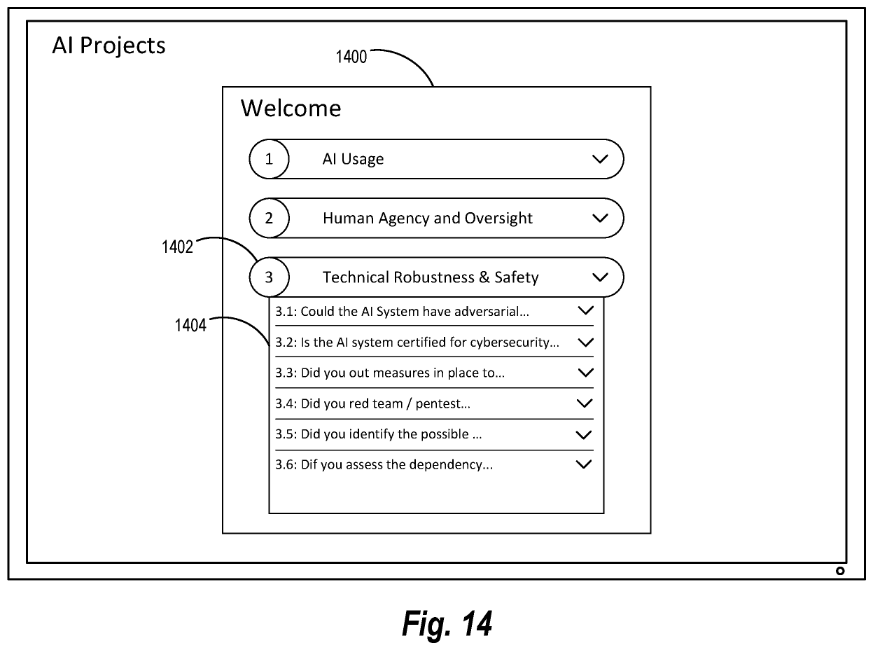

FIG. 14 illustrates an example of client device displaying an assessment survey 1400 in connection with a project and/or machine-learning model. Specifically, as illustrated, the client device displays the assessment survey 1400 to obtain additional information associated with the project or machine-learning model that the machine-learning management system 102 may not have obtained from the common data object and/or linked data objects of subcomponents. For example, the assessment survey 1400 can include topics (e.g., topic 1402) and questions (e.g., question 1404) that the machine-learning management system 102 automatically generates in response to detecting one or more missing attribute values in the common data object and/or data objects of corresponding subcomponents. Additionally or alternatively, the assessment survey 1400 can include questions provided to the machine-learning management system 102 via one or more user inputs.

As shown, the assessment survey 1400 can include questions associated with a plurality of topics related to usage of a machine-learning model in connection with the project, human involvement in the usage of the machine-learning model, controls associated with managing the use of the machine-learning model, and/or technical implementation details of the machine-learning model. In particular, the machine-learning management system 102 can determine where the machine-learning model resides, whether the machine-learning model has been trained and tested, data inputs and outputs to the machine-learning model, a purpose of the machine-learning model, impacts of the machine-learning model on other systems or models, data dependencies of model inputs/outputs, etc. The machine-learning management system 102 can automatically determine and utilize responses to the assessment survey 1400 to store attribute values of the common data object of the project and/or linked data objects or to link additional data objects to the common data object.

According to some aspects, the machine-learning management system 102 determines a risk level of a machine-learning model and/or a dataset based on the assessment survey 1400. For example, the machine-learning management system 102 can assign a risk level/weight associated with each question in the assessment survey 1400. The machine-learning management system can determine the risk level of the machine-learning model based on the risk levels/weights associated with each of the questions in the assessment survey 1400. To illustrate, in response to determining that a response to a particular question with a low weight indicates that the machine-learning model has a high risk level value, the machine-learning management system 102 can determine an overall risk level associated with the machine-learning model based on the low weight and high risk level value of the question. Additionally or alternatively, in response to determining that a response to an additional question with a high weight indicates that the machine-learning model has a low risk level value, the machine-learning management system 102 can further determine the overall risk level associated with the machine-learning model based on the high weight and low risk level value of the additional question. The machine-learning management system 102 can thus use the weights and risk level values of corresponding questions to determine the overall risk level of the machine-learning model.

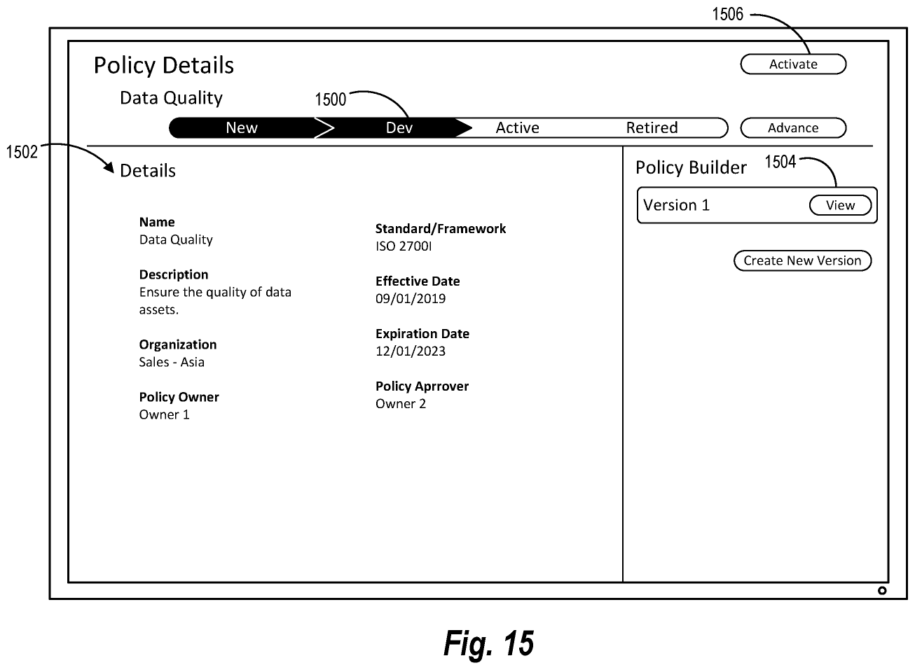

FIG. 15 illustrates an example of a client device displaying details associated with a selected system requirements framework. For example, in response to selecting a system requirements framework from one or more other graphical user interfaces, the machine-learning management system 102 obtains information associated with the system requirements framework from a digital representation (e.g., a data object) of the system requirements framework. The client device displays a configuration stage 1500 associated with the system requirements framework and details 1502 of the system requirements framework based on the retrieved information including, but not limited to, a name of the system requirements framework, a description of the system requirements framework, an organization that created the system requirements framework, a user account assigned to manage the system requirements framework for the entity, an effective date linking the system requirements framework to the project, etc. In some aspects, the client device also displays a framework version 1504 associated with the system requirements framework along with one or more options to view the current or previous versions. The client device can also display an activate element 1506 to activate the system requirements framework (including any rules associated with the system requirements framework) for a project.

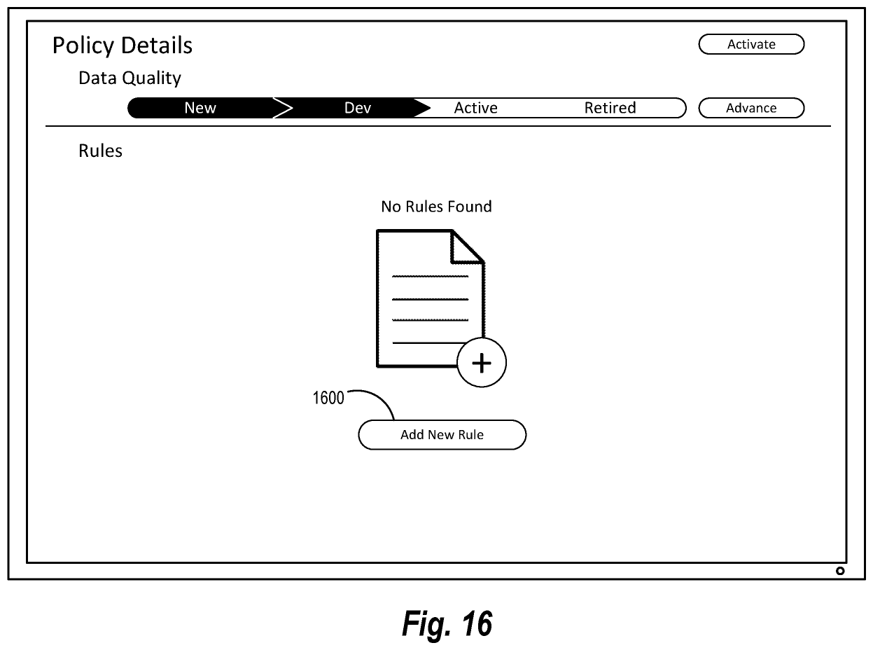

In some aspects, the machine-learning management system 102 provides tools for attaching a new system requirements framework to the project. For example, FIG. 16 illustrates a graphical user interface including an element 1600 for adding a new system requirements framework to the project in a configuration interface. To illustrate, the client device can provide tools for selecting the new system requirements framework from a list of available system requirements frameworks (e.g., via data stored in corresponding data objects) or for generating a new data object.

In some aspects, the machine-learning management system 102 automatically adds a system requirements framework to the project in response to detecting similarities of the project to another project. For instance, the machine-learning management system 102 can determine the similarities of two projects by comparing attribute values of respective common data objects and linked data objects of subcomponents. The machine-learning management system 102 can determine that a particular system requirements framework should apply to a specific project and link the data object of the system requirements framework to the common data object of the project (e.g., by adding a mapping to the data object of the system requirements framework to the common data object).

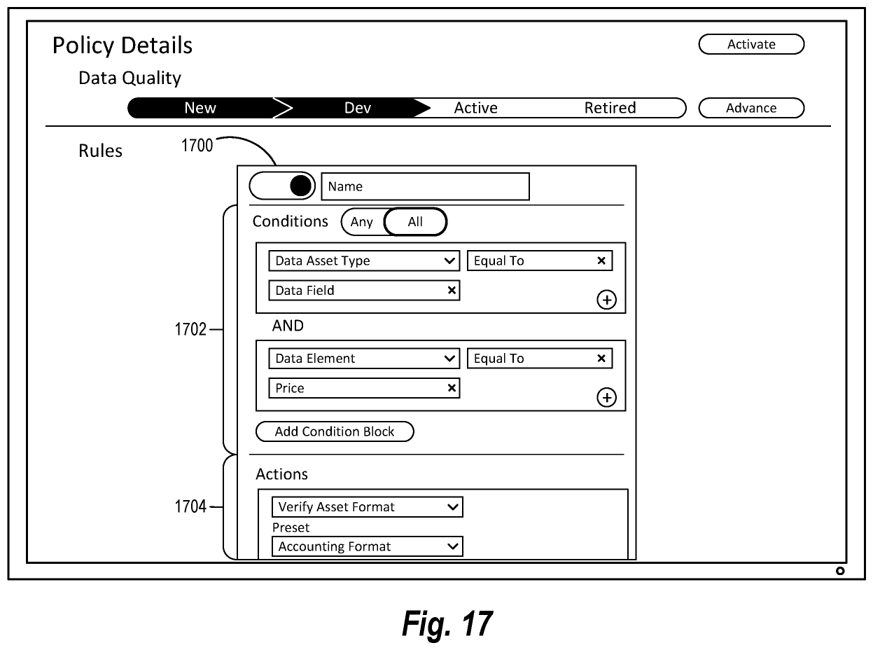

In some aspects, in response to a selection to add a new system requirements framework to a project, the machine-learning management system 102 provides a set of tools for defining the system requirements framework (e.g., within a configuration interface for generating a digital representation of a system requirements framework). Specifically, FIG. 17 illustrates a client device displaying a rule creation overlay 1700 of a configuration interface in connection with applying a system requirements framework to a project. In particular, the rule creation overlay 1700 includes a plurality of options for defining details of the system requirements framework including, but not limited to, conditions 1702 indicating controls and requirements for data assets, datasets, machine-learning models, or other subcomponents; and control actions 1704 for implementing the controls and requirements with the data assets, datasets, machine-learning models, or other subcomponents. To illustrate, the client device displays a set of options for generating a digital representation of a system requirements framework including data configuration requirements.

For example, the client device can display a plurality of options for indicating the conditions 1702 including options indicating the specific subcomponent to which a particular control applies and how the control applies to the subcomponent. As an example, FIG. 17 illustrates that a condition applies to a data asset type equal to a data field and that the data element in the data field should be equal to a “price” value. Furthermore, the control actions 1704 include options for determining requirements for the conditions 1702, such as by implementing a verification that the asset format of the indicated data asset type is in an accounting format. The client device thus provides a variety of tools for specifying a number of different controls in a system requirements framework to apply to various subcomponents. Additionally or alternatively, the machine-learning management system 102 can apply the created rules to subcomponents of the project to ensure that the storage, transmitting, formatting, modification, or processing of data associated with the subcomponents complies with one or more system requirements frameworks.

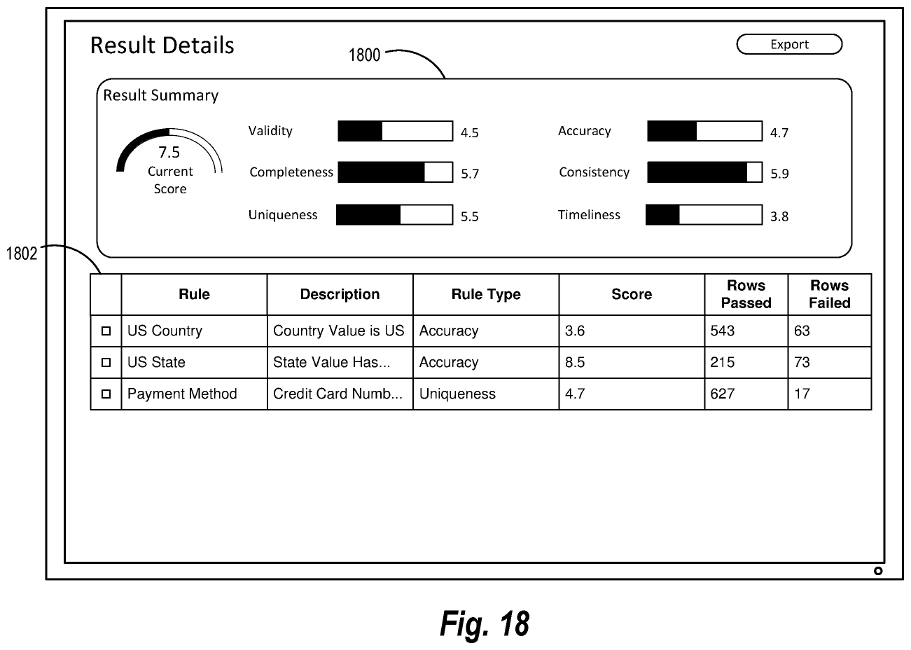

FIG. 18 illustrates an example of a client device displaying results associated with analyzing a project. Specifically, as mentioned, the machine-learning management system 102 can perform a variety of operations for analyzing and validating use of one or more machine-learning models in connection with a project utilizing a common data object linked to data objects of subcomponents. For example, as described in relation to FIG. 4, the machine-learning management system 102 can utilize the common data object to determine whether the subcomponents of the project meet data configuration requirements for one or more system requirements frameworks at various stages of development for the machine-learning model(s). Such analysis and validation can involve analyzing data input to and output by a machine-learning model, attributes of data in a dataset, attributes of a data asset, or other attributes of the subcomponents.

As illustrated in FIG. 18, the client device displays a result summary 1800 include information associated with one or more datasets and/or machine-learning models of the project. To illustrate, as previously described, the machine-learning management system 102 can determine validity, completeness, or uniqueness of data in one or more datasets. Additionally or alternatively, the machine-learning management system 102 can determine model accuracy, model consistency, or timing/processing attributes of a machine-learning model. The machine-learning management system 102 can provide the details associated with analyzing the subcomponents of the project for display via the client device in response to a request to analyze the project in connection with data configuration requirements. Alternatively, the machine-learning management system 102 can automatically perform data extraction and analysis operations in connection with generating a project, advancing a project from a first stage to a second stage, or in connection with a predetermined time interval (e.g., every day or every week).

FIG. 18 also illustrates that the client device displays information associated with one or more rules (e.g., controls and requirements) associated with a project. To illustrate, the client device displays a rules list 1802 including various rules that apply to the subcomponents of the project in connection with one or more system requirements frameworks. Additionally or alternatively, the machine-learning management system 102 can utilize the rules to determine the compliance of the subcomponents of the project with the one or more system requirements frameworks and generate the results for display within the result summary 1800. As an example, the machine-learning management system 102 can determine whether the subcomponents of the project comply with a rule indicating that a specific data type (e.g., credit card number) be encrypted and generate a score based on the compliance of the subcomponents with the rule.

In some aspects, in connection with generating or displaying results of an analysis of compliance of a project with one or more rules of a system requirements framework, the machine-learning management system 102 provides tools for modifying the subcomponents of the project. For example, in response to detecting a compliance gap (e.g., resulting in a score below a threshold for a particular subcomponent and a particular rule), the machine-learning management system 102 can generate a recommendation (e.g., a recommended action) to modify a subcomponent. The client device can display one or more options for implementing changes to the subcomponent(s) based on the recommendations.

To illustrate, the machine-learning management system 102 can generate a recommendation to change one or more values of data items in a dataset from a first value that does not comply with a rule to a second value that does comply with the rule. Additionally or alternatively, the machine-learning management system 102 can generate a recommendation to modify a dataset by encrypting data in the dataset to comply with a rule or to redact data types from the dataset that does not comply with the rule. In another example, the machine-learning management system 102 generates a recommendation to change a model type of a machine-learning model from a first model type that does not comply with a rule to a second model type that does comply with the rule (e.g., a model type requirement rule). In various aspects, the machine-learning management system 102 generates recommendations including, but not limited to, reducing the number of models used, changing training datasets for one or more models, modifying an architecture or layer of a machine-learning model, generating documentation for a machine-learning model, preventing machine-learning models from exposing certain data types, changing attributes of a data asset (e.g., increasing storage size, encrypting a storage device, moving a storage location from a third-party system to a local system), or other changes that can impact whether a particular subcomponent meets or passes a requirement indicated by a system requirements framework.

In some aspects, the machine-learning management system 102 automatically implements one or more modifications according to a configuration gap. For instance, in response to determining that a configuration gap indicates that a data type is not encrypted to comply with a particular system requirements framework, the machine-learning management system 102 can automatically encrypt the data type. To illustrate, the machine-learning management system 102 can access one or more datasets (e.g., via integration with one or more computing devices or computing applications), identify the corresponding data type, and encrypt the data type. In some aspects, the machine-learning management system 102 automatically places a hold on a machine-learning model in response to detecting a configuration gap. In additional or alternative aspects, the machine-learning management system 102 automatically implements a machine-learning model in response to correcting a configuration gap or detecting no configuration gap.

The machine-learning management system 102 can also provide an indication that a hold for implementing a machine-learning model is removed. For example, the machine-learning management system 102 can detect a change to an attribute value of a common data object for implementing a machine-learning model that causes the common data object to meet one or more data configuration requirements that caused a configuration gap. The machine-learning management system 102 can generate an indication that the hold is removed based on the updated attribute value correcting the configuration gap. In some aspects, generating the indication that the hold is removed includes removing a label or icon that indicated the hold.

In additional examples, the machine-learning management system 102 can determine that a configuration gap indicates that a machine-learning model has not been trained in accordance with a requirement of a system requirements framework. The machine-learning management system 102 can automatically initiate a process to train the machine-learning model utilizing one or more training datasets to comply with the requirement of the system requirements framework. In additional or alternative aspects, the machine-learning management system 102 utilizes a common data object to update a machine-learning model (e.g., re-train or modify parameters) according to a detected configuration gap. Specifically, the machine-learning management system 102 can modify the common data object and/or linked data objects in connection with determining updated subcomponents and utilize the updated subcomponents to modify the machine-learning model. The machine-learning management system 102 can also utilize the configuration gap to determine a retraining frequency or evaluation or code modification to prevent future configuration gaps.

In some aspects, the machine-learning management system 102 provides indications of one or more automated operations associated with a machine-learning model or project involving the machine-learning model for display via a client device. For example, the machine-learning management system 102 can generate an indication of a hold for implementing a machine-learning model for display via a graphical user interface of a client device. Additionally or alternatively, the machine-learning management system 102 can generate an indication that the machine-learning management system 102 automatically implemented a machine-learning model for display via a graphical user interface of a client device.

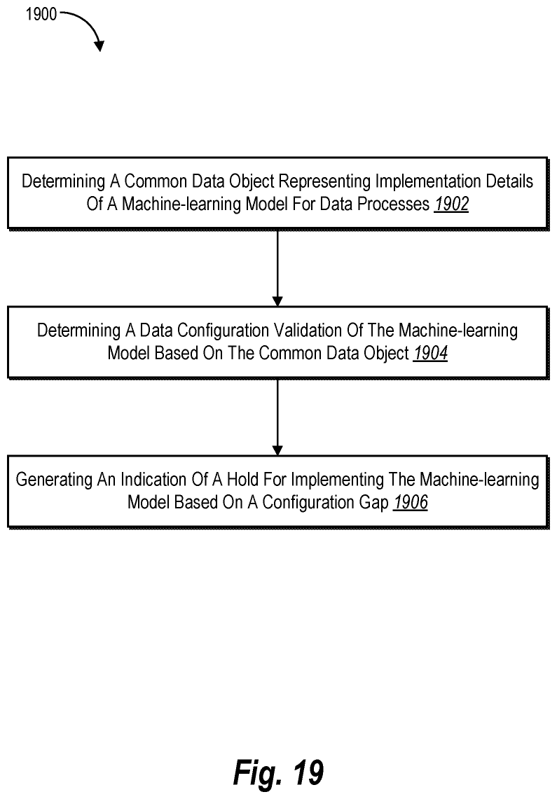

Turning now to FIG. 19, this figure shows a flowchart of a process 1900 of managing implementation of a machine-learning model and datasets via a common data object. While FIG. 19 illustrates acts according to one embodiment, alternative aspects may omit, add to, reorder, and/or modify any of the acts shown in FIG. 19. The acts of FIG. 19 can be performed as part of a method. Alternatively, a non-transitory computer readable medium can comprise instructions, that when executed by one or more processors, cause a computing device to perform the acts of FIG. 19. In still further aspects, a system (e.g., one or more system described in FIGS. 1 and 20) can perform the acts of FIG. 19.

As shown, the process 1900 includes an act 1902 of determining a common data object representing implementation details of a machine-learning model for data processes. In some aspects, act 1902 is implemented using one or more examples described above with respect to FIGS. 2-4. Additionally, the process 1900 includes an act 1904 of determining a data configuration validation of the machine-learning model based on the common data object. In one or more aspects, act 1904 is implemented using one or more examples described above with respect to FIG. 4. The process 1900 also includes an act 1906 of generating an indication of a hold for implementing the machine-learning model based on a configuration gap. In some aspects, act 1906 is implemented using one or more examples described above with respect to FIGS. 4 and 8.

In some aspects, the process 1900 includes determining, via a digital data repository, a common data object comprising attribute values representing implementation details for a machine-learning model in connection with one or more data processes within a computing system. In some aspects, the determination can be performed using an integration of a data extraction software application with the digital data repository. This can involve one or more examples described above with respect to the discovery system 500 of FIG. 5. The process 1900 can also include performing, based on the attribute values of the common data object, a data configuration validation of the machine-learning model according to a digital representation of a system requirements framework associated with the one or more data processes, the system requirements framework comprising one or more requirements for storing and handling one or more data types in one or more datasets for the one or more data processes within the computing system. This can involve performing the data configuration validation, as discussed in one or more of the examples described above with respect to FIG. 4. In some aspects, the process 1900 can further include generating, for display via a graphical user interface of a computing device, an indication of a hold for implementing the machine-learning model in response to determining that the data configuration validation indicates a configuration gap relative to the digital representation of the system requirements framework. This can involve one or more examples described above with respect to FIGS. 4 and 8. In additional or alternative aspects, the process 1900 can include generating instructions to perform the one or more data processes at one or more computing devices utilizing the machine-learning model in response to determining that the data configuration validation indicates that the common data object meets a set of data configuration requirements of the digital representation of the system requirements framework. This can involve one or more examples of generating instructions described above with respect to FIG. 4.

The process 1900 can include extracting, from the attribute values of the common data object, a configuration stage associated with the machine-learning model. This can involve one or more examples described above with respect to FIGS. 3, 4, and 8. The process 1900 can also include extracting, from the common data object, a mapping between a model object representing the machine-learning model and one or more dataset objects representing one or more datasets corresponding to the machine-learning model in connection with the one or more data processes. This can involve one or more examples described above with respect to FIGS. 3, 4, and 8.

The process 1900 can include determining, via the digital data repository, data objects representing one or more assessments and one or more risk levels associated with the machine-learning model in connection with the one or more data processes. This can involve one or more examples described above with respect to FIGS. 3, 5, 11, and 14. The process 1900 can also include generating, by modifying one or more attribute values of the common data object, mappings between the machine-learning model and the one or more assessments and the one or more risk levels. This can involve one or more examples of updating attribute values described above with respect to FIG. 5.

Additionally or alternatively, the process 1900 can include determining, from the digital representation of the system requirements framework, a set of data configuration requirements for the machine-learning model in connection with the one or more data processes. This can involve one or more examples described above with respect to FIG. 4. The process 1900 can further include comparing the attribute values of the common data object to the set of data configuration requirements. This can involve one or more examples described above with respect to FIG. 4.

Additionally or alternatively, the process 1900 can include determining, based on one or more attribute values of the common data object, a model type of the machine-learning model. This can involve one or more examples described above with respect to FIGS. 3 and 4. Furthermore, the process 1900 can include determining the configuration gap indicating that the model type does not meet a model type requirement in the set of data configuration requirements indicated in the digital representation of the system requirements framework. This can involve one or more examples described above with respect to FIG. 18.

In some aspects, the process 1900 includes determining, based on one or more attribute values of the common data object, an output dataset generated by the machine-learning model for the one or more data processes. This can involve one or more examples described above with respect to FIGS. 2, 3, and 4. The process 1900 can also include determining the configuration gap indicating that the output dataset does not meet the set of data configuration requirements from the digital representation of the system requirements framework. This can involve one or more examples described above with respect to FIG. 4.

Additionally or alternatively, the process 1900 can include determining, based on one or more attribute values of the common data object, an input dataset for the machine-learning model for the one or more data processes. This can involve one or more examples described above with respect to FIGS. 3 and 4. The process 1900 can further include determining the configuration gap indicating that the input dataset for the machine-learning model does not meet the set of data configuration requirements from the digital representation of the system requirements framework. This can involve one or more examples described above with respect to FIGS. 4 and 9.

Additionally or alternatively, the process 1900 can include determining the configuration gap indicating that a configuration stage of the machine-learning model extracted from the attribute values of the common data object does not meet a required configuration stage of the set of data configuration requirements from the digital representation of the system requirements framework. This can involve one or more examples described above with respect to FIG. 4.

Additionally or alternatively, the process 1900 can include generating, based on the configuration gap, a recommended action for modifying the machine-learning model, one or more datasets associated with the machine-learning model, or the one or more data processes. This can involve one or more examples described above with respect to FIGS. 4 and 18. The process 1900 can also include providing, for display via the graphical user interface of the computing device, the recommended action with the indication of the hold for implementing the machine-learning model. This can involve one or more examples described above with respect to FIGS. 4 and 18.

In some aspects, the process 1900 can further include detecting a change to an attribute value of the common data object correcting the configuration gap according to the digital representation of the system requirements framework. This can involve one or more examples described above with respect to FIGS. 4 and 18. The process 1900 can also include generating, for display via the graphical user interface of the computing device, an additional indication that the hold for implementing the machine-learning model is removed. This can involve one or more examples described above with respect to FIGS. 4 and 18.

In some aspects, the process 1900 can include extracting, from the attribute values of the common data object, a configuration stage associated with the machine-learning model and one or more indications of one or more datasets corresponding to the machine-learning model in connection with the one or more data processes. This can involve one or more examples described above with respect to FIG. 4. The process 1900 can also include determining one or more dataset objects representing the one or more datasets corresponding to the machine-learning model based on one or more mappings between a model object corresponding to the machine-learning model and the one or more dataset objects according to the attribute values of the common data object. This can involve one or more examples described above with respect to FIG. 3.

In some aspects, the process 1900 can also include determining, based on the attribute values of the common data object, an output dataset generated by the machine-learning model in connection with the one or more data processes. This can involve one or more examples described above with respect to FIGS. 2, 3, and 4. Additionally, the process 1900 can include determining that the output dataset is within a threshold of an expected output dataset according to the set of data configuration requirements of the system requirements framework. This can involve one or more examples described above with respect to FIGS. 3 and 4.

In some aspects, the process 1900 can further include determining, based on the attribute values of the common data object, that the common data object has passed a plurality of data configuration validations corresponding to a plurality of configuration stages associated with the machine-learning model. This can involve one or more examples described above with respect to FIG. 4. The process 1900 can also include generating instructions that cause the one or more computing devices to execute the one or more data processes utilizing the machine-learning model in response to determining that the common data object has passed the plurality of data configuration validations. This can involve one or more examples described above with respect to FIG. 4.

Additionally or alternatively, the process 1900 can include extracting, from the common data object, a set of attribute values corresponding to the machine-learning model, one or more datasets associated with the machine-learning model, and one or more assessments associated with the machine-learning model in connection with the one or more data processes. This can involve one or more examples described above with respect to FIG. 3. The process 1900 can further include providing, for display within graphical user interface of a computing device, an interactive summary comprising the set of attribute values in connection with implementing the machine-learning model for the one or more data processes within the computing system. This can involve one or more examples described above with respect to FIG. 6.

Additionally or alternatively, the process 1900 can include extracting, from the common data object, a dataset identifier associated with a dataset utilized to train the machine-learning model in connection with the one or more data processes. This can involve one or more examples described above with respect to FIGS. 3 and 9. The process 1900 can also include generating, for display within graphical user interface of a computing device, an interactive graphical element comprising a link to a data analysis of the dataset utilized to train the machine-learning model. This can involve one or more examples described above with respect to FIG. 9.

In some aspects, the process 1900 includes determining, via a digital data repository, a common data object comprising attribute values representing implementation details for a machine-learning model in connection with one or more data processes and one or more datasets within a computing system. This can involve one or more examples described above with respect to FIGS. 2-4. The process 1900 can include determining, based on the attribute values of the common data object and one or more dataset objects representing the one or more datasets, a data configuration validation of the machine-learning model indicating one or more configuration gaps according to a digital representation of a system requirements framework associated with the one or more data processes. This can involve one or more examples described above with respect to FIG. 4. The process 1900 can further include generating, for display via a graphical user interface of a computing device, one or more tasks to modify the machine-learning model or the one or more datasets according to the one or more configuration gaps. This can involve one or more examples described above with respect to FIGS. 4 and 18.

Additionally or alternatively, the process 1900 can include determining one or more attribute values of the common data object corresponding to the one or more configuration gaps. This can involve one or more examples described above with respect to FIGS. 3 and 4. The process 1900 can include generating the one or more tasks to modify the machine-learning model or the one or more datasets according to the one or more attribute values corresponding to the one or more configuration gaps. This can involve one or more examples described above with respect to FIGS. 4 and 18.

In some aspects, the process 1900 can also include providing, for display via the graphical user interface of the computing device, a configuration interface comprising a plurality of options for generating the digital representation of the system requirements framework in connection with the one or more data processes. This can involve one or more examples described above with respect to FIGS. 16 and 17. The process 1900 can further include generating the digital representation of the system requirements framework comprising a set of data configuration requirements according to selected options of the plurality of options. This can involve one or more examples described above with respect to FIG. 17.

Aspects described in the present disclosure may comprise or utilize a special purpose or general-purpose computer including computer hardware, such as, for example, one or more processors and system memory, as discussed in greater detail below. Aspects within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, aspects of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some aspects, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Aspects of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 20 illustrates a block diagram of exemplary computing device 2000 that may be configured to perform one or more of the processes described above. One will appreciate that one or more computing devices such as the computing device 2000 may implement the system(s) of FIG. 1. As shown by FIG. 20, the computing device 2000 can comprise a processor 2002, a memory 2004, a storage device 2006, an I/O interface 2008, and a communication interface 2010, which may be communicatively coupled by way of a communication infrastructure 2012. In certain aspects, the computing device 2000 can include fewer or more components than those shown in FIG. 20. Components of the computing device 2000 shown in FIG. 20 will now be described in additional detail.

In some aspects, the processor 2002 includes hardware for executing instructions, such as those making up a computer program. As an example, and not by way of limitation, to execute instructions for dynamically modifying workflows, the processor 2002 may retrieve (or fetch) the instructions from an internal register, an internal cache, the memory 2004, or the storage device 2006 and decode and execute them. The memory 2004 may be a volatile or non-volatile memory used for storing data, metadata, and programs for execution by the processor(s). The storage device 2006 includes storage, such as a hard disk, flash disk drive, or other digital storage device, for storing data or instructions for performing the methods described herein.

The I/O interface 2008 allows a user to provide input to, receive output from, and otherwise transfer data to and receive data from computing device 2000. The I/O interface 2008 may include a mouse, a keypad or a keyboard, a touch screen, a camera, an optical scanner, network interface, modem, other known I/O devices or a combination of such I/O interfaces. The I/O interface 2008 may include one or more devices for presenting output to a user, including, but not limited to, a graphics engine, a display (e.g., a display screen), one or more output drivers (e.g., display drivers), one or more audio speakers, and one or more audio drivers. In certain aspects, the I/O interface 2008 is configured to provide graphical data to a display for presentation to a user. The graphical data may be representative of one or more graphical user interfaces and/or any other graphical content as may serve a particular implementation.

The communication interface 2010 can include hardware, software, or both. In any event, the communication interface 2010 can provide one or more interfaces for communication (such as, for example, packet-based communication) between the computing device 2000 and one or more other computing devices or networks. As an example, and not by way of limitation, the communication interface 2010 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 2010 may facilitate communications with various types of wired or wireless networks. The communication interface 2010 may also facilitate communications using various communication protocols. The communication infrastructure 2012 may also include hardware, software, or both that couples components of the computing device 2000 to each other. For example, the communication interface 2010 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary aspects thereof. Various aspects and aspects of the present disclosure(s) are described with reference to details discussed herein, and the accompanying drawings illustrate the various aspects. The description above and drawings are illustrative of the disclosure and are not to be construed as limiting the disclosure. Numerous specific details are described to provide a thorough understanding of various aspects of the present disclosure.

The present disclosure may be embodied in other specific forms without departing from its spirit or essential characteristics. The described aspects are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A method comprising:
determining, by at least one computer processor via an integration of a data extraction software application with a digital data repository, a common data object comprising attribute values representing implementation details for a machine-learning model in connection with one or more data processes within a computing system;
determining, by the at least one computer processor and based on the attribute values of the common data object, a data configuration validation of the machine-learning model according to a digital representation of a system requirements framework associated with the one or more data processes, the system requirements framework comprising one or more requirements for storing and handling one or more data types in one or more datasets for the one or more data processes within the computing system; and
generating, by the at least one computer processor for display via a graphical user interface of a computing device, an indication of a hold for implementing the machine-learning model in response to determining that the data configuration validation indicates a configuration gap relative to the digital representation of the system requirements framework.

2. The method of claim 1, wherein determining the common data object comprises:
extracting, from the attribute values of the common data object, a configuration stage associated with the machine-learning model; and
extracting, from the common data object, a mapping between a model object representing the machine-learning model and one or more dataset objects representing one or more datasets corresponding to the machine-learning model in connection with the one or more data processes.

3. The method of claim 1, wherein determining the common data object comprises:
determining, via the digital data repository, data objects representing one or more assessments and one or more risk levels associated with the machine-learning model in connection with the one or more data processes; and
generating, by modifying one or more attribute values of the common data object, mappings between the machine-learning model and the one or more assessments and the one or more risk levels.

4. The method of claim 1, wherein determining the data configuration validation comprises:
determining, from the digital representation of the system requirements framework, a set of data configuration requirements for the machine-learning model in connection with the one or more data processes; and
comparing the attribute values of the common data object to the set of data configuration requirements.

5. The method of claim 4, wherein determining the data configuration validation comprises:
determining, based on one or more attribute values of the common data object, a model type of the machine-learning model; and
determining the configuration gap indicating that the model type does not meet a model type requirement in the set of data configuration requirements indicated in the digital representation of the system requirements framework.

6. The method of claim 4, wherein determining the data configuration validation comprises:
determining, based on one or more attribute values of the common data object, an output dataset generated by the machine-learning model for the one or more data processes; and
determining the configuration gap indicating that the output dataset does not meet the set of data configuration requirements from the digital representation of the system requirements framework.

7. The method of claim 4, wherein determining the data configuration validation comprises:
determining, based on one or more attribute values of the common data object, an input dataset for the machine-learning model for the one or more data processes; and
determining the configuration gap indicating that the input dataset for the machine-learning model does not meet the set of data configuration requirements from the digital representation of the system requirements framework.

8. The method of claim 4, wherein determining the data configuration validation comprises determining the configuration gap indicating that a configuration stage of the machine-learning model extracted from the attribute values of the common data object does not meet a required configuration stage of the set of data configuration requirements from the digital representation of the system requirements framework.

9. The method of claim 1, wherein generating the indication of the hold for implementing the machine-learning model comprises:
generating, based on the configuration gap, a recommended action for modifying the machine-learning model, one or more datasets associated with the machine-learning model, or the one or more data processes; and
providing, for display via the graphical user interface of the computing device, the recommended action with the indication of the hold for implementing the machine-learning model.

10. The method of claim 1, further comprising:
detecting a change to an attribute value of the common data object correcting the configuration gap according to the digital representation of the system requirements framework; and
generating, for display via the graphical user interface of the computing device, an additional indication that the hold for implementing the machine-learning model is removed.

11. A system comprising:
one or more non-transitory computer readable media comprising a digital data repository; and
at least one computer processor configured to cause the system to:
determine, via the digital data repository, a common data object comprising attribute values representing implementation details for a machine-learning model in connection with one or more data processes within a computing system;
determine, based on the attribute values of the common data object, a data configuration validation of the machine-learning model according to a digital representation of a system requirements framework associated with the one or more data processes; and
generate instructions to perform the one or more data processes at one or more computing devices utilizing the machine-learning model in response to determining that the data configuration validation indicates that the common data object meets a set of data configuration requirements of the digital representation of the system requirements framework.

12. The system of claim 11, wherein the at least one computer processor is further configured to cause the system to determine the common data object by extracting, from the attribute values of the common data object, a configuration stage associated with the machine-learning model and one or more indications of one or more datasets corresponding to the machine-learning model in connection with the one or more data processes.

13. The system of claim 12, wherein the at least one computer processor is further configured to cause the system to determine one or more dataset objects representing the one or more datasets corresponding to the machine-learning model based on one or more mappings between a model object corresponding to the machine-learning model and the one or more dataset objects according to the attribute values of the common data object.

14. The system of claim 11, wherein the at least one computer processor is configured to cause the system to determine the data configuration validation of the machine-learning model by:
determining, based on the attribute values of the common data object, an output dataset generated by the machine-learning model in connection with the one or more data processes; and
determining that the output dataset is within a threshold of an expected output dataset according to the set of data configuration requirements of the system requirements framework.

15. The system of claim 11, wherein the at least one computer processor is configured to cause the system to:
determine the data configuration validation of the machine-learning model by determining, based on the attribute values of the common data object, that the common data object has passed a plurality of data configuration validations corresponding to a plurality of configuration stages associated with the machine-learning model; and
generate the instructions to perform the one or more data processes by generating instructions that cause the one or more computing devices to execute the one or more data processes utilizing the machine-learning model in response to determining that the common data object has passed the plurality of data configuration validations.

16. The system of claim 11, wherein the at least one computer processor is configured to cause the system to:
extract, from the common data object, a set of attribute values corresponding to the machine-learning model, one or more datasets associated with the machine-learning model, and one or more assessments associated with the machine-learning model in connection with the one or more data processes; and
provide, for display within graphical user interface of a computing device, an interactive summary comprising the set of attribute values in connection with implementing the machine-learning model for the one or more data processes within the computing system.

17. The system of claim 11, wherein the at least one computer processor is configured to cause the system to:
extract, from the common data object, a dataset identifier associated with a dataset utilized to train the machine-learning model in connection with the one or more data processes; and
generate, for display within graphical user interface of a computing device, an interactive graphical element comprising a link to a data analysis of the dataset utilized to train the machine-learning model.

18. A non-transitory computer readable medium comprising instructions that, when executed by at least one computer processor, cause the at least one computer processor to:
determine, via a digital data repository, a common data object comprising attribute values representing implementation details for a machine-learning model in connection with one or more data processes and one or more datasets within a computing system;
determine, based on the attribute values of the common data object and one or more dataset objects representing the one or more datasets, a data configuration validation of the machine-learning model indicating one or more configuration gaps according to a digital representation of a system requirements framework associated with the one or more data processes; and
generate, for display via a graphical user interface of a computing device, one or more tasks to modify the machine-learning model or the one or more datasets according to the one or more configuration gaps.

19. The non-transitory computer readable medium of claim 18, further comprising instructions that, when executed by the at least one computer processor, cause the at least one computer processor to generate the one or more tasks to modify the machine-learning model or the one or more datasets by:
determining one or more attribute values of the common data object corresponding to the one or more configuration gaps; and
generating the one or more tasks to modify the machine-learning model or the one or more datasets according to the one or more attribute values corresponding to the one or more configuration gaps.

20. The non-transitory computer readable medium of claim 18, further comprising instructions that, when executed by the at least one computer processor, cause the at least one computer processor to:
provide, for display via the graphical user interface of the computing device, a configuration interface comprising a plurality of options for generating the digital representation of the system requirements framework in connection with the one or more data processes; and
generate the digital representation of the system requirements framework comprising a set of data configuration requirements according to selected options of the plurality of options.
